(19) United States
(12) Patent Application Publication
(10) Pub. No.: US 2013/0327705 A1
(43) Pub. Date: Dec. 12, 2013

(54) HEATED COLLECTORS, NONWOVEN MATERIALS PRODUCED THEREFROM, AND METHODS RELATING THERETO

(71) Applicants: Edward J. Clark, Pearisburg, VA (US); Sanjay Wahal, Appleton, WI (US); Jeffrey S. Conley, Narrows, VA (US)

(72) Inventors: Edward J. Clark, Pearisburg, VA (US); Sanjay Wahal, Appleton, WI (US); Jeffrey S. Conley, Narrows, VA (US)

(21) Appl. No.: 13/492,083

(22) Filed: Jun. 8, 2012

(51) Int. Cl. B32B 5/02; G10K 11/00; D04H 13/00

(52) U.S. Cl. CPC B32B 5/022; D04H 13/00; G10K 11/00
USPC 210/508; 442/63; 428/174; 264/171.13; 181/294

(57) ABSTRACT

Generally, in situ core/skin nonwoven materials may be produced from polymer melt filaments with collection in a heated collector. an in situ core/skin nonwoven material produced with heated collectors may have, at least, a core comprising a plurality of polymer melt filaments and a skin on at least one side of the core, which may advantageously translate to unique structural characteristics, properties, and applications not previously realized.

### BACKGROUND

The present invention relates to the production of nonwoven materials, and more specifically, to heated collectors for polymer melt filaments, in situ core/skin nonwoven materials produced therefrom, and methods relating thereto.

Nonwoven fabric is a term of art that refers to a manufactured sheet, batting, webbing, or fabric that is held together by various methods. Those methods include, for example, fusion of fibers (e.g., thermal, ultrasonic, pressure, and the like), bonding of fibers (e.g., resins, solvents, adhesives, and the like), and mechanical entangling (e.g., needle-punching, hydroentangling, and the like). The term is sometimes used broadly to cover other structures such as those held together by interlacing of yarns (stitch bonding) or those made from perforated or porous films. The term excludes woven, knitted, and tufted structures, paper, and felts made by wet milling processes.

Traditionally, nonwoven materials are produced by two methods: carding or airlaying from staple fibers and production from polymer melt filaments. Generally, carding of staple fibers often causes some of the staple fibers and pieces thereof to become airborne, which may collect in the equipment leading to increased maintenance and possible downtime. Further, airborne fibers pose inhalation and dermal irritation risks to workers.

Because of the significant investment in capital equipment for carding and health issues associated with processing bales of staple fiber, the production of nonwoven materials from polymer melt filaments has been of interest to one skilled in the art. As used herein, the term “polymer melt filaments,” and derivatives thereof, refers to the filaments produced from a polymer melt, which may include, but are not limited to, spunbond filaments, meltblown filaments, and electrospun filaments.

Most commonly, nonwoven materials that include thermoplastic filaments are produced from a polymer melt. Nonwoven materials from polymer melt filaments are generally produced by extruding the filaments from a polymer melt, attenuating the filaments to a desired filament diameter, collecting the filaments on a conveyor or rotating drum to form a web, and optionally further bonding the web through hydroentangling, adhesively bonding, or thermal bonding processes. Traditionally, nonwoven materials and products produced from polymer melt filaments have a low caliper and substantially homogeneous cross-sectional makeup. As used herein, the term “caliper” refers to thickness. Therefore, nonwoven materials produced from polymer melt filaments have a limited use in areas such as surgical drapes, disposable diapers, and wipes. Applications that use higher caliper nonwovens, e.g., insulation, filtration, sorbents, and some textiles (e.g., fillings for jackets, sleeping bags, blankets, etc.), are limited primarily to nonwovens produced from carding processes as well as airlaid processes, which present the problems described above.

Typically, caliper is increased by, for example, laying of the filaments on a moving conveyor traveling slower than the filaments are produced, which allows for the filaments to accumulate and pile to thereby increase the caliper of the web. This process of increasing caliper has limitations, however, including, but not limited to, increased weight of the web and reduced the interfiber bonding, each of which have ramifications of increased weight and/or decreased strength in the final nonwoven material. Further, the subsequent steps to enhance interfiber bonding of the web to form the nonwoven material usually reduce the caliper, thereby yielding a nonwoven material with a relatively low caliper.

Further, because nonwoven materials from polymer melt filaments traditionally may have a substantially homogeneous cross-sectional makeup, additional processing may be required to produce nonwoven products with complex structures, e.g., a nonwoven product with a higher density of polymer melt filaments on the surface versus in the center.

Apparatuses and methods that may be used to increase the caliper and decrease the density of webs of polymer melt filaments while maintaining basis weight, thereby increasing the caliper and decreasing the density of the resultant nonwoven materials produced therefrom, may be of benefit to one skilled in the art.

Further, apparatuses and methods that can produce nonwoven materials with complex structures in fewer, and perhaps single, steps may be of benefit to one skilled in the art.

### SUMMARY OF THE INVENTION

The present invention relates to the production of nonwoven materials, and more specifically, to heated collectors for polymer melt filaments, in situ core/skin nonwoven materials produced therefrom, and methods relating thereto.

One embodiment of the present invention may be an in situ nonwoven comprising: a skin formed in situ on at least one outer side of a core.

Another embodiment of the present invention may be a method comprising: forming a plurality of polymer melt filaments; and passing the plurality of polymer melt filaments through a heated collector thereby forming an in situ nonwoven material that comprises a skin formed in situ on at least one outer side of a core.

Yet another embodiment of the present invention may be a system comprising: at least one polymer melt extruder having a plurality of dies; and a heated collector in communication with the at least one extruder to receive a plurality of polymer melt filaments from the at least one extruder to form an in situ nonwoven material that comprises a skin formed in situ on at least one outer side of a core.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modifications, alterations, combinations, and equivalents in form and function, as will occur to those skilled in the art and having the benefit of this disclosure.

FIG. 1 provides a nonlimiting illustration of two density profiles of an in situ core/skin nonwoven material according to some embodiments of the present invention.

FIGS. 2A-C provide nonlimiting illustrations of physical structures of in situ core/skin nonwoven materials according to at least some embodiments of the present invention.

FIG. 3 provides an illustration of a bimodal and trimodal diameter distributions.

FIGS. 4A-C illustrate hypothetical nonlimiting examples of cross-sections of in situ core/skin nonwoven materials of the present invention having segregated configurations.

FIGS. 5A-C provide illustrations of nonlimiting examples of heated collectors of the present invention.

FIG. 6 illustrates a perspective view of a nonlimiting example of a heated collector of the present invention with Venturi flow capabilities for use in conjunction with a system of the present invention.

FIG. 7 illustrates a side view, partially in section, of a nonlimiting example of a heated collector of the present invention with Venturi flow capabilities for use in conjunction with a system of the present invention.

FIG. 8 illustrates a top view of the housing of a nonlimiting example of a heated collector of the present invention with Venturi flow capabilities for use in conjunction with a system of the present invention.

FIG. 9 illustrates an end view illustrating the outlet opening in the housing of a nonlimiting example of a heated collector of the present invention with Venturi flow capabilities for use in conjunction with a system of the present invention.

FIGS. 10A-B illustrate a view of two different embodiments of the side plates of the housing of a nonlimiting example of a heated collector of the present invention with Venturi flow capabilities for use in conjunction with a system of the present invention.

FIG. 11 illustrates an end view of the inlet opening of the housing of a nonlimiting example of a heated collector of the present invention with Venturi flow capabilities for use in conjunction with a system of the present invention.

FIG. 12 illustrates a perspective view of a nonlimiting example of a heated collector of the present invention with Venturi flow capabilities for use in conjunction with a system of the present invention.

FIG. 13 illustrates a view of one of the side plates of the housing of a nonlimiting example of a heated collector of the present invention with Venturi flow capabilities for use in conjunction with a system of the present invention.

FIG. 14 illustrates a perspective view of a nonlimiting example of a heated collector of the present invention with Venturi flow capabilities for use in conjunction with a system of the present invention.

FIG. 15 provides an illustration of a nonlimiting example of a system of the present invention for forming in situ core/skin nonwoven materials of the present invention.

FIG. 16 provides an illustration of a nonlimiting example of a system of the present invention having two heated collectors of the present invention in series.

FIGS. 17A-B provide photographs of an example of a produced in situ core/skin nonwoven material with an end-on view and a side-on view, respectively.

FIG. 17C provides a top view of the core of a produced in situ core/skin nonwoven material with the skins removed.

FIGS. 18A-B provide scanning electron micrographs of the core and top skin of a produced in situ core/skin nonwoven material at different magnifications (12× and 50×, respectively).

FIGS. 19A-C provide scanning electron micrographs of the core of a produced in situ core/skin nonwoven material at different magnifications (25×, 85×, and 1700×, respectively).

FIGS. 20A-E provide scanning electron micrographs of the skin of a produced in situ core/skin nonwoven material in a top down view at different magnifications (22×, 200×, 700×, 1700×, and 500×, respectively).

FIGS. 21A-B provide sound dampening data for an in situ core/skin nonwoven material according to at least one embodiment of the present invention.

FIG. 22 provides sound dampening data for an in situ core/skin nonwoven material according to at least one embodiment of the present invention.

FIG. 23 provides sound dampening data for an in situ core/skin nonwoven material according to at least one embodiment of the present invention.

FIG. 24 provides sound dampening data for an in situ core/skin nonwoven material according to at least one embodiment of the present invention.

FIG. 25 provides a top view of an in situ core/skin nonwoven material according to at least one embodiment of the present invention.

FIG. 26 provides a side view of a core of an in situ core/skin nonwoven material according to at least one embodiment of the present invention.

FIGS. 27A-B provide scanning electron micrographs of a top view of a skin of an in situ core/skin nonwoven material according to at least one embodiment of the present invention at different magnifications (30× and 500×, respectively).

FIG. 28 provides a scanning electron micrograph at 55× magnification of a side view of a core of an in situ core/skin nonwoven material according to at least one embodiment of the present invention.

FIG. 29 provides a scanning electron micrograph at 25× magnification of a side view of a core interface with a skin of an in situ core/skin nonwoven material according to at least one embodiment of the present invention.

FIG. 30 provides sound dampening data for an in situ core/skin nonwoven material according to at least one embodiment of the present invention.

FIG. 31 provides sound dampening data for an in situ core/skin nonwoven material according to at least one embodiment of the present invention.

### DETAILED DESCRIPTION

The present invention relates to the production of nonwoven materials, and more specifically, to heated collectors for polymer melt filaments, in situ core/skin nonwoven materials produced therefrom, and methods relating thereto.

In some embodiments, the present invention provides in situ core/skin nonwoven materials having an in situ generated core and skin produced with a process involving a heated collector. The in situ generated core and skin structures may, in some embodiments, have unique density profiles that allow the resulting nonwoven articles and products to provide for unique filtration characteristics, enhanced oil and/or water absorbency, low air permeability, low thermal conductivity, and/or improved sound dampening qualities. Further, the in situ core/skin nonwoven materials of the present invention advantageously have combinations of these properties with, in some instances, uniquely smaller calipers, which enables or enhances a plurality of end-use applications, e.g., insulation with high thermal insulation properties and good acoustic insulating properties for vehicles or high-precision instrumentation. Further, the in situ generated core and skin structures may, in some embodiments, provide rigidity in the resultant in situ core/skin nonwoven materials while also providing at least one of the aforementioned characteristics. As used herein, the term “density profile” refers to the density of the structure along a cross-sectional line perpendicular to the production direction. In some embodiments, the present invention provides for systems, apparatuses, and methods for producing in situ core/skin nonwoven materials of the present invention in a minimal number of steps with a minimal amount of equipment. At least in some embodiments presented herein, this may be a single-step, single-apparatus approach that reduces, or may eliminate, subsequent processing steps, which in turn is believed to save money and time.

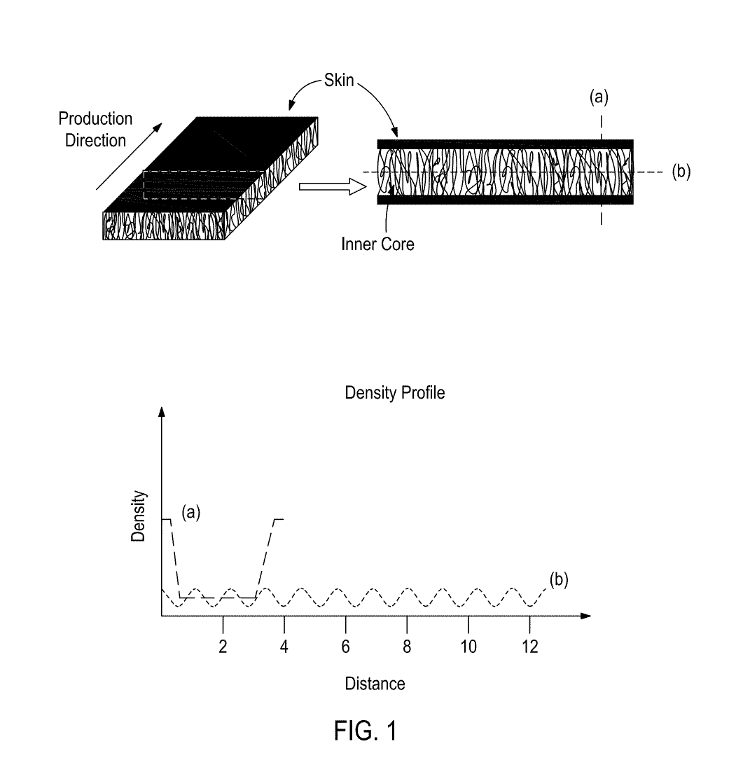

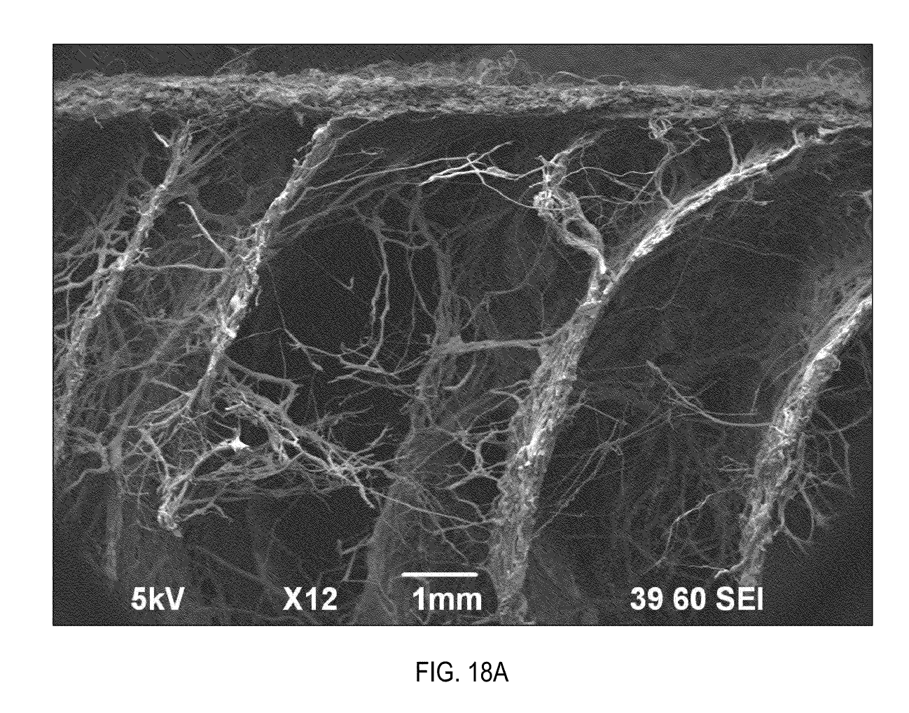

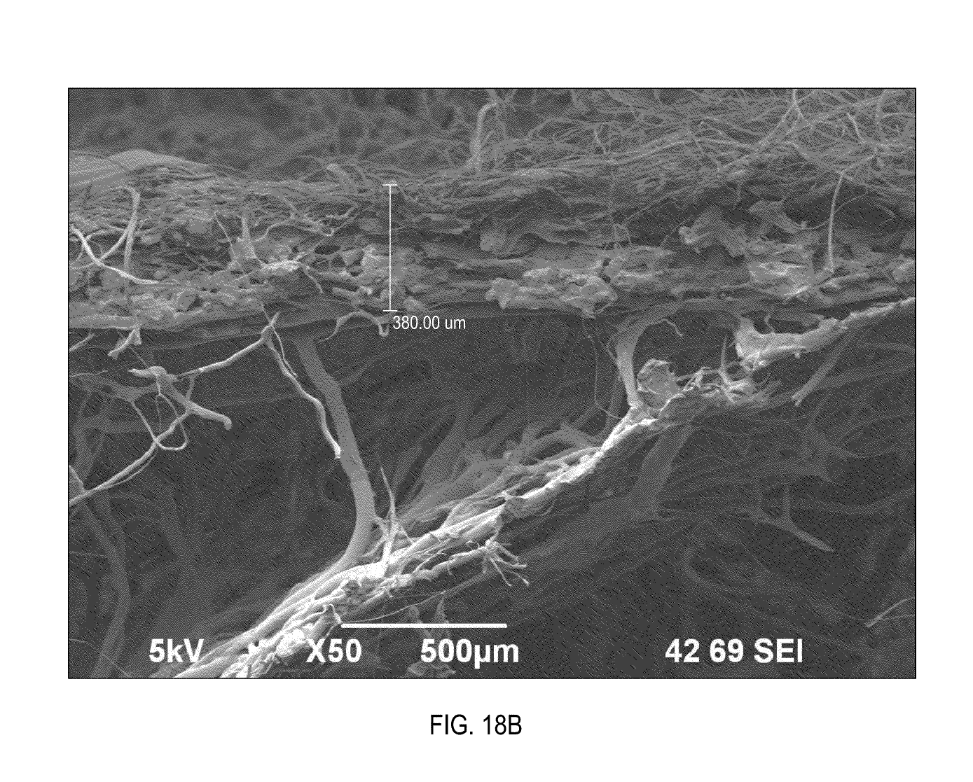

FIG. 1 provides a nonlimiting illustration of two density profiles of an in situ core/skin nonwoven material according to at least some embodiments of the present invention. It should be noted, that while FIG. 1 illustrates density profile lines in two directions (a) and (b), density profile lines may be drawn as any cross-sectional line perpendicular to the production direction. It should be noted that FIGS. 1, 2, 15, and 16 illustrate the skin as a solid component for clearer delineation between the core and the skin. However, as described further herein, the skin is a collection of polymer melt filaments as shown in FIGS. 18A-B, 20A-E, and 29.

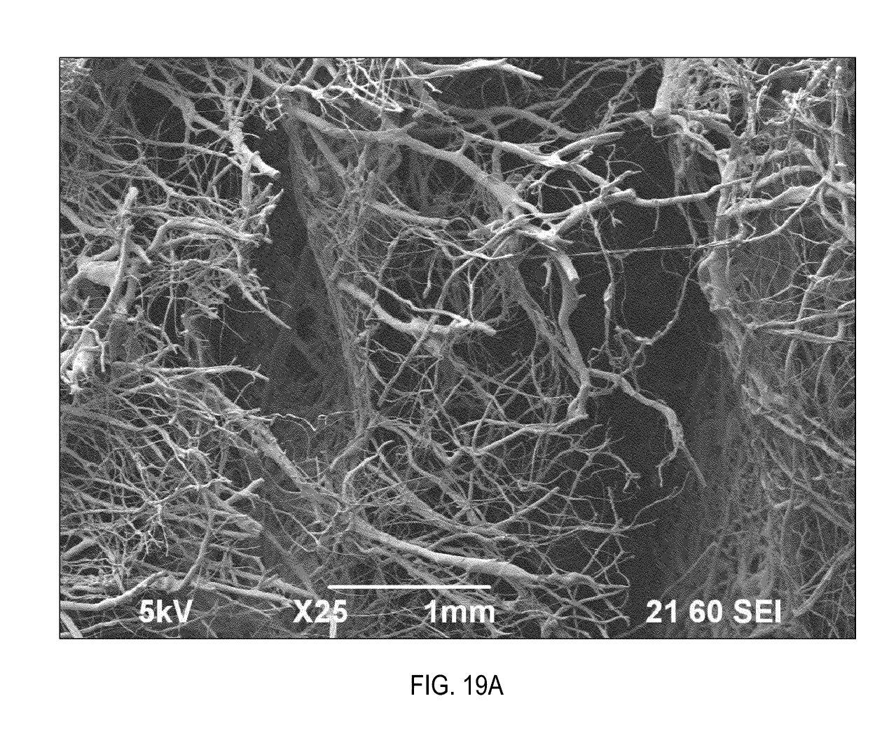

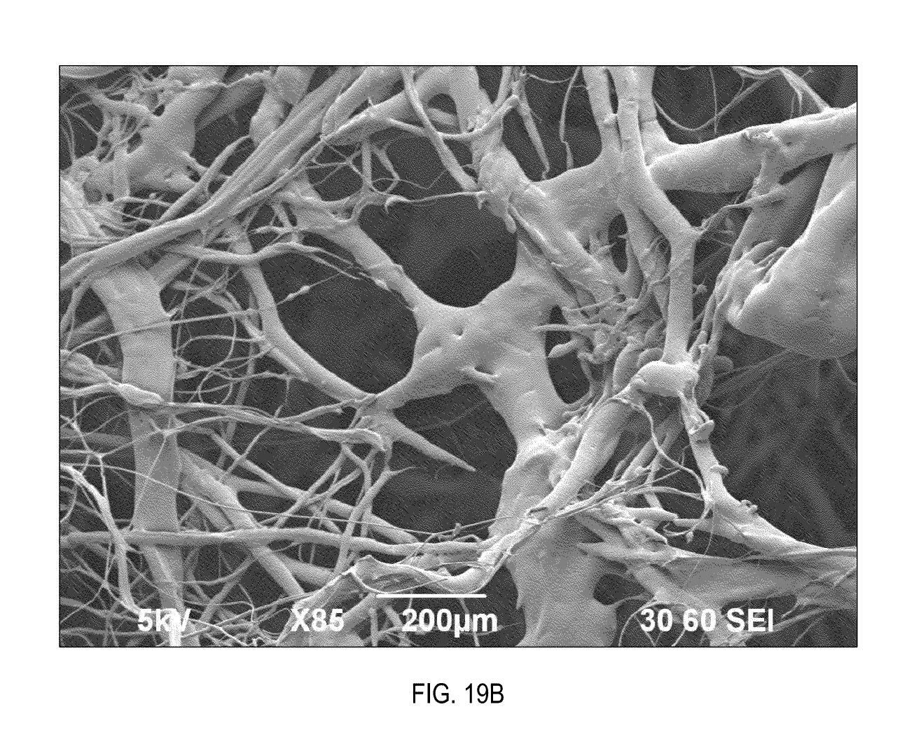

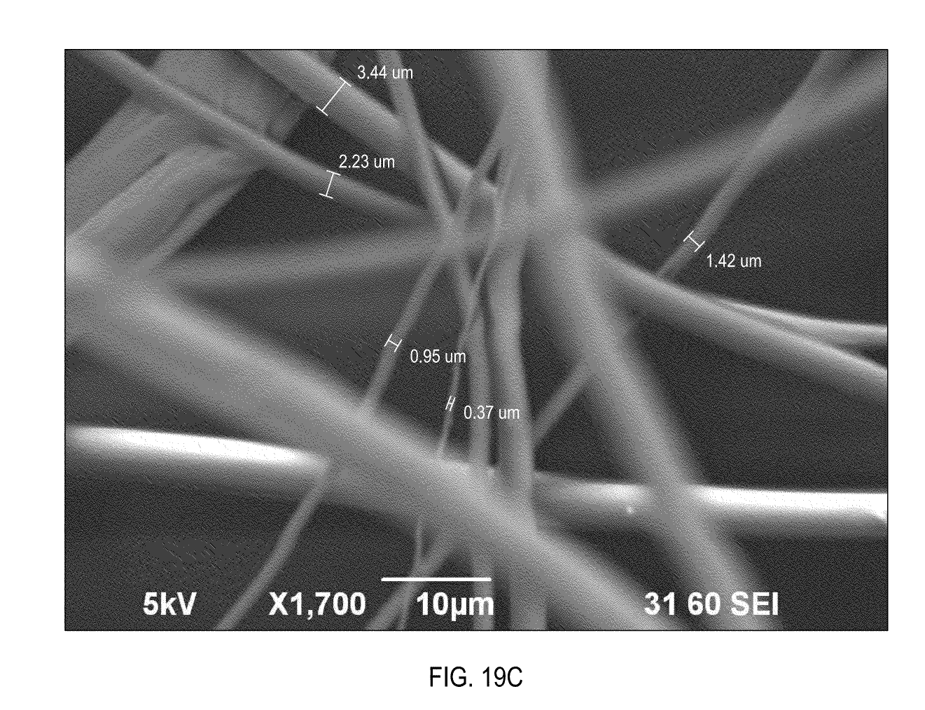

Finally, the apparatuses and processes of the present invention may, in some embodiments, provide for in situ generated core and skin structures that comprise submicron fibers, as shown in FIG. 19C, due to factors involving, inter alia, the die, high velocity flow from the air, attenuating section, and the like. The presence of the submicron fibers in the resulting in situ core/skin nonwoven materials may add surface area to help with absorbency, filtration, and insulation properties of the nonwoven.

### I. Structure

The systems described herein are believed to enable, in at least some embodiments, the production of in situ core/skin nonwoven materials from polymer melt filaments that have unique structural features. As used herein, the term “polymer melt filaments,” and derivatives thereof, refers to the filaments produced from a polymer melt, which may include, but not be limited to, spunbond filaments, meltblown filaments, and electrospun filaments. The compositions and further description of polymer melt filaments suitable for use in conjunction with the present invention are provided further herein.

In some embodiments, the unique structural features may manifest in the physical structure of the in situ core/skin nonwoven materials, in the diameter distribution of the polymer melt filaments of the in situ core/skin nonwoven materials, in the caliper of the in situ core/skin nonwoven materials, in the bulk density of the in situ core/skin nonwoven materials, in the basis weight of the in situ core/skin nonwoven materials, in the flexural rigidity of the in situ core/skin nonwoven materials, in the density profile of the in situ core/skin nonwoven materials, or any combination thereof. As used herein, the term “caliper” refers to thickness. As used herein, the term “basis weight” refers to the weight per unit area. As used herein, the term “flexural rigidity” refers to a material's resistance to bending.

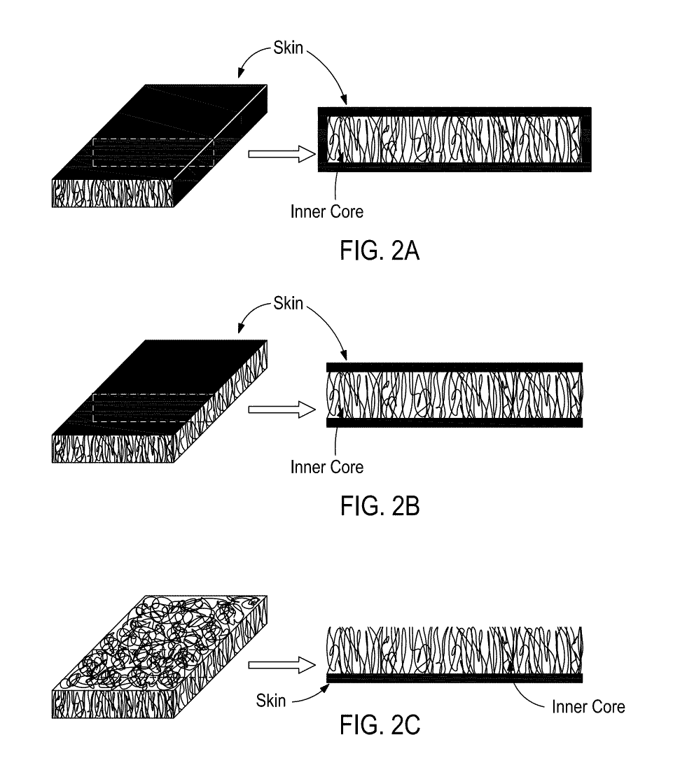

Referring to FIGS. 2A-C, nonlimiting illustrations of physical structures of in situ core/skin nonwoven materials according to at least some embodiments of the present invention, the in situ core/skin nonwoven materials generally have a core with entangled polymer melt filaments and a skin on at least one side. FIG. 2A illustrates a skin on the top, bottom, and sides; FIG. 2B illustrates a skin on the top and bottom; and FIG. 2C illustrates a skin on the bottom. It should be understood that directional terms referring to figures are for assistance in understanding the figures and should not be read as limiting to the structure or function of the elements of the figures. As used herein, the term “skin” refers to an integumentary covering that is generally more dense than the core of the in situ core/skin nonwoven material, yet still fibrous in natures.

In some embodiments, the in situ core/skin nonwoven materials of the present invention may have a skin formed in situ on at least one outer side of a core, for example as illustrated in the nonlimiting examples of FIGS. 2A-2C. In some embodiments, in situ core/skin nonwoven materials of the present invention may have a skin formed in situ on at least two opposing sides of a core, for example as illustrated in the nonlimiting examples of FIG. 2A-B.

In some embodiments, a skin of the in situ core/skin nonwoven materials of the present invention may have a thickness of about 50 microns or greater. In some embodiments, the skin of the in situ core/skin nonwoven materials of the present invention may have a thickness ranging from a lower limit about 50 microns, 100 microns, or 250 microns to an upper limit of about 1000 microns, 750 microns, 500 microns, or 250 microns, and wherein the thickness of the skin may range from any lower limit to any upper limit and encompass any subset therebetween. In some embodiments, the skin may be greater than 1 mm, for example, up to 5 mm. By way of nonlimiting example, in situ core/skin nonwoven materials with thicker skins and higher caliper cores, both of which are fibrous in nature, may be especially useful for thermal insulation and/or sound dampening.

In some embodiments, the core may have a substantially homogeneous entanglement of polymer melt filaments throughout. In some embodiments, the polymer melt filaments of the core may form a substructure, which may include, but is not limited to, corrugated-like or gill-like structures (each of which are demonstrated in the examples section). In some embodiments, the substructure may have a varying density profile, e.g., across the machine-direction, as illustrated in the nonlimiting example provided in FIG. 1 as density profile (b). In some embodiments, a substructure of the core may integrate into the skin of an in situ core/skin nonwoven material of the present invention, e.g., as illustrated in Example 3 below.

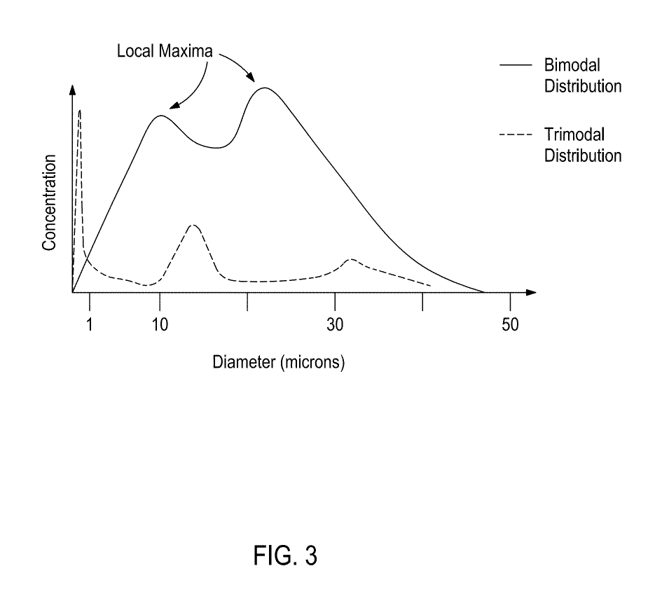

In some embodiments, the core of the in situ core/skin nonwoven materials of the present invention may have polymer melt filaments with a monomodal diameter distribution. In some embodiments, the core of the in situ core/skin nonwoven materials of the present invention may have polymer melt filaments with a polymodal diameter distribution, e.g., bimodal or trimodal. As used herein, the term “mode” when referring to diameter distributions refers to a local maxima in the diameter distribution. FIG. 3 provides an illustration of a hypothetical bimodal and trimodal diameter distribution, i.e., a diameter distribution having two or three local maxima, respectively.

In some embodiments, the core of the in situ core/skin nonwoven materials of the present invention may have polymer melt filaments with an average diameter (or at least one mode of a polymodal diameter distribution having an average diameter) ranging from a lower limit of about 100 nm, 250 nm, 500 nm, or 1 micron to an upper limit of about 10 microns, 5 microns, or 1 micron, wherein the average diameter of the polymer melt filaments of the core of the in situ core/skin nonwoven materials of the present invention may range from any lower limit to any upper limit and encompass any subset therebetween.

In some embodiments, the skin of the in situ core/skin nonwoven materials of the present invention may have polymer melt filaments with a monomodal diameter distribution. In some embodiments, the skin of the in situ core/skin nonwoven materials of the present invention may have polymer melt filaments with a polymodal diameter distribution, e.g., bimodal or trimodal. In some embodiments, the skin of the in situ core/skin nonwoven materials of the present invention may have polymer melt filaments with at least one mode of a polymodal diameter distribution having an average diameter ranging from a lower limit of about 1 micron, 5 microns, 10 microns, or 25 microns to an upper limit of about 100 microns, 75 microns, 50 microns, or 25 microns, wherein the average diameter of the polymer melt filaments of the skin of the in situ core/skin nonwoven materials of the present invention may range from any lower limit to any upper limit and encompass any subset therebetween.

In some embodiments, the core and the skin of the in situ core/skin nonwoven materials of the present invention may have polymer melt filaments with diameter distributions such that at least one mode of the core diameter distribution and at least one mode of the skin diameter distribution are substantially nonoverlapping. As used herein, the term “substantially nonoverlapping” refers to at least 75% of each mode being different. In determining mode overlap for complex and/or multimodal diameter distributions, it may be necessary to perform a Gaussian curve-fit to define each mode. In some embodiments, the largest diameter mode of the diameter distribution of the polymer melt filaments of the skin may be substantially nonoverlapping with the smallest diameter mode of the diameter distribution of the polymer melt filaments of the core.

In some embodiments, the core may comprise polymer melt filaments with smaller diameters than the polymer melt filaments of the skin of the in situ core/skin nonwoven materials of the present invention. In some embodiments of the present invention, the smallest diameter mode of the diameter distribution of the polymer melt filaments of the core may be about 10 to about 1000 times smaller than the largest diameter mode of the diameter distribution of the polymer melt filaments of the skin. In some embodiments of the present invention, the ratio of the largest diameter mode of the diameter distribution of the polymer melt filaments of the skin to the smallest diameter mode of the diameter distribution of the polymer melt filaments of the core may range from a lower limit of about 10:1, 25:1, 50:1, 100:1, or 500:1 to an upper limit of about 1000:1, 500:1, or 100:1, wherein the diameter ratio may range from any lower limit to any upper limit and encompass any subset therebetween.

In some embodiments of the present invention, the core and the skin of the in situ core/skin nonwoven materials of the present invention may have polymer melt filaments with average diameters such that at least one mode of the core has an average diameter that is about 50% or less of the average diameter of at least one mode of the skin diameter distribution, or about 25% or less, or more preferably about 10% or less. By way of nonlimiting example, an in situ core/skin nonwoven material of the present invention may have a core with polymer melt filaments having an average diameter of about 2 microns and a skin with polymer melt filaments having a diameter distribution mode with an average diameter of about 25 microns, i.e., the core has polymer melt filaments that are about 8% of the diameter of the average diameter of the mode of the skin diameter distribution.

In some embodiments, the in situ core/skin nonwoven materials of the present invention may have a caliper of about 3 mm or greater. In some embodiments, the in situ core/skin nonwoven materials of the present invention may have a caliper ranging from a lower limit of about 3 mm, 5 mm, 10 mm, 15 mm, 25 mm, or 50 mm to an upper limit of about 250 mm, 200 mm, 150 mm, 100 mm, or 50 mm, and wherein the caliper of the in situ core/skin nonwoven materials of the present invention may range from any lower limit to any upper limit and encompass any subset therebetween.

In some embodiments, the in situ core/skin nonwoven materials of the present invention may have a bulk density of about 0.5 g/cm³ or less. In some embodiments, in situ core/skin nonwoven materials of the present invention may have a bulk density ranging from a lower limit of about 0.002 g/cm³, 0.005 g/cm³, 0.01 g/cm³, or 0.05 g/cm³ to an upper limit of about 0.5 g/cm³, 0.25 g/cm³, 0.2 g/cm³, or 0.1 g/cm³, and wherein the bulk density of in situ core/skin nonwoven materials of the present invention may range from any lower limit to any upper limit and encompass any subset therebetween. By way of nonlimiting example, an insulation may comprise an in situ core/skin nonwoven material of the present invention with an average bulk density of about 0.013 g/cm³.

In some embodiments, the in situ core/skin nonwoven materials of the present invention may have a basis weight of about 1500 g/m² or less. In some embodiments, in situ core/skin nonwoven materials of the present invention may have a basis weight ranging from a lower limit of about 100 g/m², 250 g/m², or 500 g/m² to an upper limit of about 1500 g/m², 1250 g/m², 1000 g/m², or 750 g/m², and wherein the basis weight of in situ core/skin nonwoven materials of the present invention may range from any lower limit to any upper limit and encompass any subset therebetween. The basis weight may be related to several factors including, but not limited to, the amount of material being processed through the die, how fast the material is processed through the die, and the rate at which the in situ core/skin nonwoven material is collected.

In some embodiments, suitable polymer melt filaments for use in conjunction with the present invention may comprise thermoplastic polymers. Suitable polymers for use in producing polymer melt fibers may include, but are not limited to, ultrahigh molecular weight polyethylenes, very high molecular weight polyethylenes, high molecular weight polyethylenes, polyolefins, polyesters, polyamides, nylons, polyacrylics, polystyrenes, polyvinyls, polytetrafluoroethylenes, polyether ether ketones, non-fibrous plasticized celluloses, polyethylenes, polypropylenes, polybutylenes, polymethylpentenes, low-density polyethylenes, linear low-density polyethylenes, high-density polyethylenes, polyethylene terephthalates, polybutylene terephthalates, polycyclohexylene dimethylene terephthalates, polytrimethylene terephthalates, polymethyl methacrylates, polystyrenes, acrylonitrile-butadiene-styrenes, styrene-acrylonitriles, styrene-butadienes, styrene-maleic anhydrides, ethylene vinyl acetates, polyvinyl chlorides, cellulose acetates, cellulose acetate butyrates, plasticized cellulosics, cellulose propionates, ethyl celluloses, any derivative thereof, any blend polymer thereof, any copolymer thereof, or any combination thereof. By way of nonlimiting example, in situ core/skin nonwoven materials of the present invention comprising polypropylene polymer melt filaments may be useful in applications of oil absorbency, e.g., oil booms.

In some embodiments, suitable polymer melt filaments for use in conjunction with the present invention may be bicomponent fibers. Suitable configurations for bicomponent fibers may include, but not be limited to, side-by-side, sheath-core, segmented-pie, islands-in-the-sea, tipped, segmented-ribbon, or any hybrid thereof.

Suitable polymer melt filaments for use in conjunction with the present invention may have any cross-sectional shape including, but not limited to, circular, substantially circular, crenulated, ovular, substantially ovular, ribboned, polygonal, substantially polygonal, dog-bone, “Y,” “X,” “K,” “C,” multi-lobe, and any hybrid thereof. As used herein, the term “multi-lobe” refers to a cross-sectional shape having a point (not necessarily in the center of the cross-section) from which at least two lobes extend (not necessarily evenly spaced or evenly sized).

In some embodiments, polymer melt filaments for use in conjunction with the present invention may comprise additives. Suitable additives for use in conjunction with the present invention may include, but are not limited to, active particles, active compounds, chelating agents, ion exchange resins, superabsorbent polymers, zeolites, nanoparticles, ceramic particles, abrasive particulates, absorbent particulates, softening agents, plasticizers, pigments, dyes, flavorants, aromas, controlled-release vesicles, binders, adhesives, tackifiers, surface modification agents, lubricating agents, emulsifiers, vitamins, peroxides, biocides, antifungals, antimicrobials, deodorizers, antistatic agents, flame retardants, antifoaming agents, degradation agents, conductivity modifying agents, stabilizing agents, or any combination thereof. Said additives are detailed further herein.

In some embodiments, the in situ core/skin nonwoven materials of the present invention may comprise more than one type of polymer melt filaments, e.g., differing in composition, cross-sectional shape, additives, or any combination thereof. In some embodiments, the in situ core/skin nonwoven materials of the present invention may comprise more than one type of polymer melt filament in a relational configuration to each other. Suitable relational configurations may include, but are not limited to, substantially homogeneous or substantially segregated. One skilled in the art with the benefit of this disclosure should understand that substantially segregated provides for a cross-sectional configuration having sections that each substantially comprise a desired type of polymer melt filament and that adjacent sections may have entanglement between their respective types of polymer melt filaments.

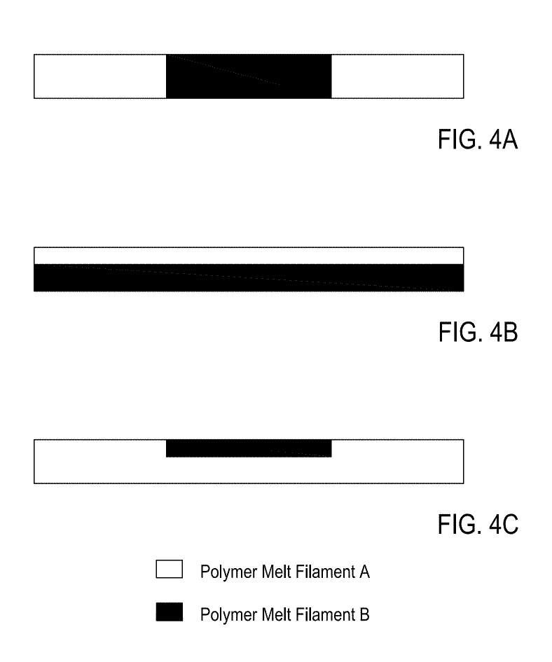

Examples of substantially segregated configurations may include, but are not limited to, side-by-side, stacked, or any combination thereof, the production of which are discussed further herein. FIGS. 4A-C illustrate nonlimiting examples of cross-sections of in situ core/skin nonwoven materials having segregated configuration of side-by-side, stacked, and combination thereof. FIG. 4A illustrates a side-by-side configuration where the cross-section from left-to-right comprises polymer melt filament A then polymer melt filament B then polymer melt filament A. FIG. 4B illustrates a stacked configuration where the cross-section from top-to-bottom comprises polymer melt filament A then polymer melt filament B. FIG. 4C illustrates a combination side-by-side and stacked configuration where the cross-section from left-to-right comprises polymer melt filament A then a stacked polymer melt filament B on top of polymer melt filament A then polymer melt filament A.

In some embodiments, the in situ core/skin nonwoven materials of the present invention may have a skin formed in situ on at least one outer side of a core, wherein the skin and the core comprise polymer melt filaments. Optionally, in some embodiments, the in situ core/skin nonwoven materials of the present invention may be characterized by the thickness of the skin, the substructure of the core (or lack thereof, i.e., a substantially homogeneous core), the density profile of the in situ core/skin nonwoven material, the density profile of the core, the diameter distribution of the polymer melt filaments of the core, the diameter distribution of the polymer melt filaments of the skin, the diameter distribution of the polymer melt filaments of the core relative to the diameter distribution of the polymer melt filaments of the skin, the caliper of the in situ core/skin nonwoven material, the bulk density of the in situ core/skin nonwoven material, the basis weight of the in situ core/skin nonwoven material, the tensile strength of the in situ core/skin nonwoven material, the composition of the polymer melt filaments, the structure of the polymer melt filament (e.g., bicomponent filaments), the cross-sectional shape of the polymer melt filaments, the additives of the polymer melt filaments, the relational configuration of more than one type of the polymer melt filaments, or any combination thereof according to any embodiments described herein.

### II. Properties

In some embodiments, the in situ core/skin nonwoven materials of the present invention may have properties that are useful in a variety of applications. Said properties may include, but are not limited to, absorbency (oil and/or water), air permeability/resistivity, fluid permeability, filtration properties, sound dampening properties, thermal conductivity properties, or any combination thereof.

In some embodiments, the in situ core/skin nonwoven materials of the present invention may be oil absorbent, water absorbent, or some combination thereof. It should be noted that one skilled in the art with the benefit of this disclosure should understand that oil absorbency and water absorbency include absorbency of fluids miscible therewith, for example, oil absorbency characteristics may include absorption of fluids like diesel fuel, crude oils, olefins, synthetic oils, siloxanes, and the like, where water absorbency characteristics may include absorption of fluids like water, brines, polyols, glycerins, and the like. One skilled in the art with the benefit of this disclosure should understand that fluid absorbency (e.g., oil versus water absorbency) is dependent on, inter alia, the composition of the polymer melt filaments and the structure of the in situ core/skin nonwoven material (e.g., the location and density of the skin of the in situ core/skin nonwoven material). By way of nonlimiting example, polymer melt filaments comprising ethylene vinyl acetate copolymer and/or polypropylene may provide for oil absorbent in situ core/skin nonwoven materials. By way of another nonlimiting example, polymer melt filaments comprising cellulose acetate may provide for water absorbency. By way of yet another nonlimiting example, fluid absorbency and retention may be enhanced where the in situ core/skin nonwoven materials comprises a core substantially surrounded by a skin, e.g., FIG. 2A as compared to FIG. 2C.

Oil absorbency may be measured by a plurality of methods. As used herein, oil absorbency can be measured by placing an in situ core/skin nonwoven material sample in 10w30 Pennzoil motor oil. Once the sample sinks and stays submerged for one minute, the sample is removed from the motor oil and allowed to drain for two minutes. The weight of the sample after draining is divided by the weight of the sample before testing to provide an oil absorbency measure with the units g/g.

In some embodiments, the in situ core/skin nonwoven materials of the present invention may have an oil absorbency measure of about 2 g/g or greater. That is, an in situ core/skin nonwoven material of the present invention may, in some embodiments, absorb about two times or greater of its weight in 10w30 motor oil after sinking with one minute submersion. In some embodiments, the in situ core/skin nonwoven materials of the present invention may have an oil absorbency measure ranging from a lower limit of about 2 g/g, 5 g/g, 10 g/g, or 25 g/g to an upper limit of about 200 g/g, 150 g/g, 100 g/g, or 50 g/g, and wherein the oil absorbency measure may range from any lower limit to any upper limit and encompass any subset therebetween. In some embodiments, an in situ core/skin nonwoven material of the present invention may, in some embodiments, absorb from about two times (about five times, or about ten times) to about fifty times (about 40 times or about 30 times) its weight in 10w30 motor oil after sinking with one minute submersion.

Water absorbency may be measured by a plurality of methods. As used herein, water absorbency is measured by placing an in situ core/skin nonwoven material sample in deionized water. Once the sample sinks and stays submerged for one minute, the sample is removed from the water and allowed to drain for two minutes. The weight of the sample after draining is divided by the weight of the sample before testing to provide a water absorbency measure with the units g/g.

In some embodiments, the in situ core/skin nonwoven materials of the present invention may have a water absorbency measure of about 2 g/g or greater. That is, an in situ core/skin nonwoven material of the present invention may, in some embodiments, absorb about two times or greater of its weight in water after sinking with one minute submersion. In some embodiments, the in situ core/skin nonwoven materials of the present invention may have a water absorbency measure ranging from a lower limit of about 2 g/g, 5 g/g, 10 g/g, or 25 g/g to an upper limit of about 200 g/g, 150 g/g, 100 g/g, or 50 g/g, and wherein the water absorbency measure may range from any lower limit to any upper limit and encompass any subset therebetween. In some embodiments, an in situ core/skin nonwoven material of the present invention may, in some embodiments, absorb from about two times (about five times, or about ten times) to about fifty times (about 40 times or about 30 times) its weight in water after sinking with one minute submersion.

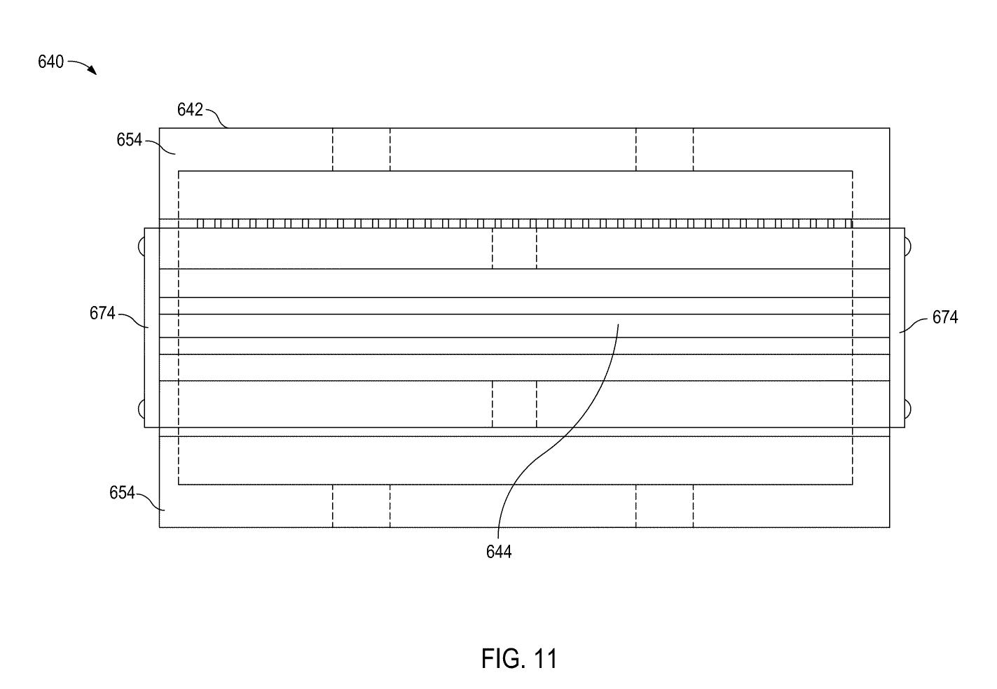

In some embodiments, the in situ core/skin nonwoven materials of the present invention may have an air flow resistivity of about 250 Rayles or greater. One suitable method for determining air flow resistivity includes the standard procedure provided in ASTM C522. In some embodiments, the in situ core/skin nonwoven materials of the present invention may have an air flow resistivity ranging from a lower limit of about 250 Rayles, 500 Rayles, or 750 Rayles to an upper limit of about 1500 Rayles, 1250 Rayles, or 1000 Rayles, wherein the air flow resistivity of the in situ core/skin nonwoven materials of the present invention may range from any lower limit to any upper limit and encompass any subset therebetween. One skilled in the art with the benefit of this disclosure should understand that the air flow resistivity of in situ core/skin nonwoven materials may depend on, inter alia, the diameter distribution of the polymer melt filaments in the core and skin, the density of the core and the skin, the basis weight of the in situ core/skin nonwoven material, and the caliper of the in situ core/skin nonwoven material. In some embodiments, the skin may comprise polymer melt filaments with a diameter distribution and density distribution such that the skin is permeable, e.g., as shown in FIG. 11B. In some embodiments, the skin may comprise substantially coalesced polymer melt filaments such that the skin is substantially solid and retains minimal fiber characteristics, space which consequently may lead to an increased fluid flow resistance, i.e., a reduced permeability.

In some embodiments, the in situ core/skin nonwoven materials of the present invention may have an air permeability of about 750 cfm/ft² or less. In some embodiments, the in situ core/skin nonwoven materials of the present invention may have an air permeability of about 50 cfm/ft² or less. One suitable method for determining the air permeability includes the standard procedure provided in ASTM D737. In some embodiments, the in situ core/skin nonwoven materials of the present invention may have an air permeability ranging from a lower limit of about 5 cfm/ft², 10 cfm/ft², 30 cfm/ft², 50 cfm/ft², 100 cfm/ft², 200 cfm/ft², or 250 cfm/ft² to an upper limit of about 750 cfm/ft², 600 cfm/ft², 500 cfm/ft², or 400 cfm/ft², and wherein the air permeability may range from any lower limit to any upper limit and encompass any subset therebetween.

One skilled in the art with the benefit of this disclosure should understand that the air flow resistivity and the air permeability is dependent on, inter alia, the diameter distribution of the polymer melt filaments in the core and skin, the density of the core and the skin, the basis weight of the in situ core/skin nonwoven material, and the caliper of the in situ core/skin nonwoven material. By way of nonlimiting example, an in situ core/skin nonwoven material according to FIG. 2A may have a higher air flow resistivity and a lower air permeability than an in situ core/skin nonwoven material according to FIG. 2C across the thickness of the in situ core/skin nonwoven material because FIG. 2A comprises skin on either side across the thickness of the in situ core/skin nonwoven material where FIG. 2C comprises skin on only one side across the thickness of the in situ core/skin nonwoven material.

In some embodiments, the in situ core/skin nonwoven materials of the present invention may have a normal incidence absorption coefficient (a measure of sound absorption) of about 0.4 or greater over a frequency range from about 1250 Hz to about 6400 Hz for thickness of about 0.5 inches or less. One suitable method for determining the normal incidence absorption coefficient includes the standard procedure provided in ASTM E-1050. In some embodiments, the in situ core/skin nonwoven materials of the present invention may have a normal incidence absorption coefficient of about 0.4 or greater over a frequency range from a lower limit of about 1250 Hz, 1500 Hz, 2000 Hz, or 2500 Hz to an upper limit of about 3000 Hz, 5000 Hz, or 6400 Hz for a thickness of about 0.5 inches or less, and wherein the normal incidence absorption coefficient inflection point may range from any lower limit to any upper limit and encompass any subset therebetween.

In some embodiments, the in situ core/skin nonwoven materials of the present invention may have a normal incidence absorption coefficient of about 0.04 or greater over a frequency range from a lower limit of about 200 Hz, 250 Hz, 300 Hz, or 400 Hz to an upper limit of about 2000 Hz, 1500 Hz, 1000 Hz, 750 Hz, or 500 Hz for a thickness of about 0.5 inches or less, and wherein the normal incidence absorption coefficient inflection point may range from any lower limit to any upper limit and encompass any subset therebetween.

In some embodiments, the in situ core/skin nonwoven materials of the present invention may have a thermal resistance as measured by an R-value between about 1.25 hr*ft²*° F./Btu and about 2.5 hr*ft²*° F./Btu for a thickness of about 0.5 inches. One suitable method for determining the R-value for thermal conductivity includes the standard procedure provided in ASTM C518. In some embodiments, the in situ core/skin nonwoven materials of the present invention may have an R-value for thermal conductivity ranging from a lower limit of about 1.25 hr*ft²*° F./Btu, 1.5 hr*ft²*° F./Btu, or 1.75 hr*ft²*° F./Btu to an upper limit of about 2.5 hr*ft²*° F./Btu, 2.25 hr*ft²*° F./Btu, or 2.0 hr*ft²*° F./Btu for a thickness of about 0.5 inches, and wherein the normal incidence absorption coefficient inflection point may range from any lower limit to any upper limit and encompass any subset therebetween.

In some embodiments, the in situ core/skin nonwoven materials of the present invention may comprise polymer melt filaments and have a core with a skin on at least one outer side of the core. Optionally, in some embodiments, the in situ core/skin nonwoven materials of the present invention may be designed with a variety of characteristics, as described above, so as to yield desired properties, e.g., an oil absorbency measure of about 2 g/g or greater, a water absorbency measure of about 2 g/g or greater, an air flow resistivity of about 250 Rayles or greater, an air permeability of about 750 cfm/ft² or less, a normal incidence absorption coefficient of about 0.5 or greater over a frequency range from about 1250 Hz to about 6400 Hz for a thickness of about 0.5 inches or less, an R-value between about 1.25 hr*ft²*° F./Btu and about 2.5 hr*ft²*° F./Btu, and suitable combinations thereof, including any subset of any property range. By way of nonlimiting example, an in situ core/skin nonwoven material of the present invention may have an air flow resistivity of about 500 Rayles or greater in combination with a normal incidence absorption coefficient of about 0.5 or greater over a frequency range from about 1650 Hz to about 6400 Hz for a thickness of about 0.5 inches or less and an R-value between about 1.5 hr*ft²*° F./Btu and about 2.0 hr*ft²*° F./Btu.

### III. Systems for and Methods of Production

In some embodiments, forming in situ core/skin nonwoven materials of the present invention may involve forming a skin on at least a portion of a core substantially simultaneous to forming the core. In some embodiments, forming in situ core/skin nonwoven materials of the present invention may involve forming a plurality of polymer melt filaments into a skin and a core substantially simultaneously such that the skin is disposed on at least a portion of the core.

In some embodiments of the present invention, forming in situ core/skin nonwoven materials of the present invention may comprise extruding a plurality of polymer melt filaments and passing the plurality of polymer melt filaments through a heated collector. In some embodiments, heated collectors of the present invention may generally comprise an enclosure with at least one wall, an inlet, and an outlet. In some embodiments, a heated collector may have at least a portion of at least one wall at an elevated temperature. Without being limited by theory, it is believed that heated walls of the heated collector allow for coalescence of nearby polymer melt filaments thereby forming the skin of the in situ core/skin nonwoven materials of the present invention.

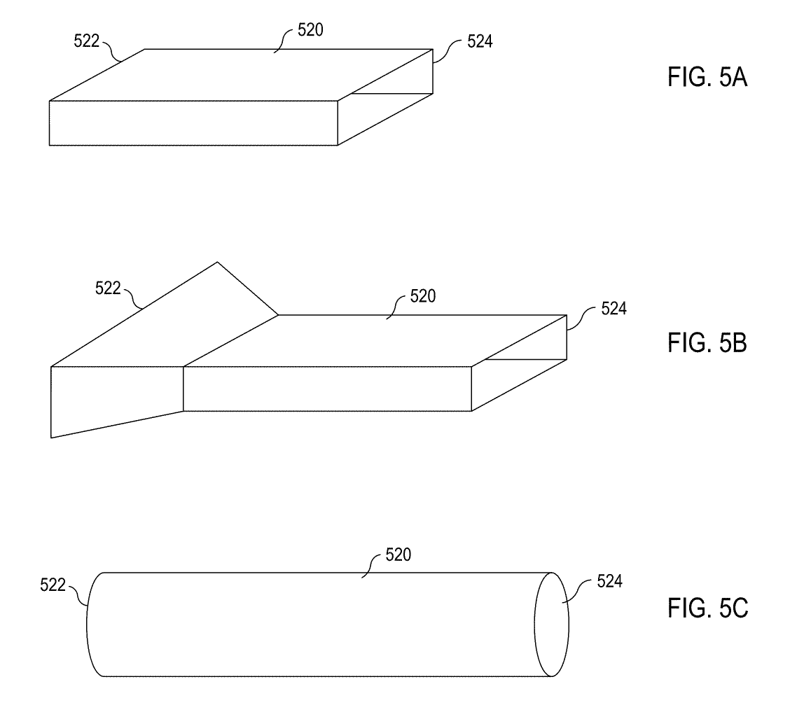

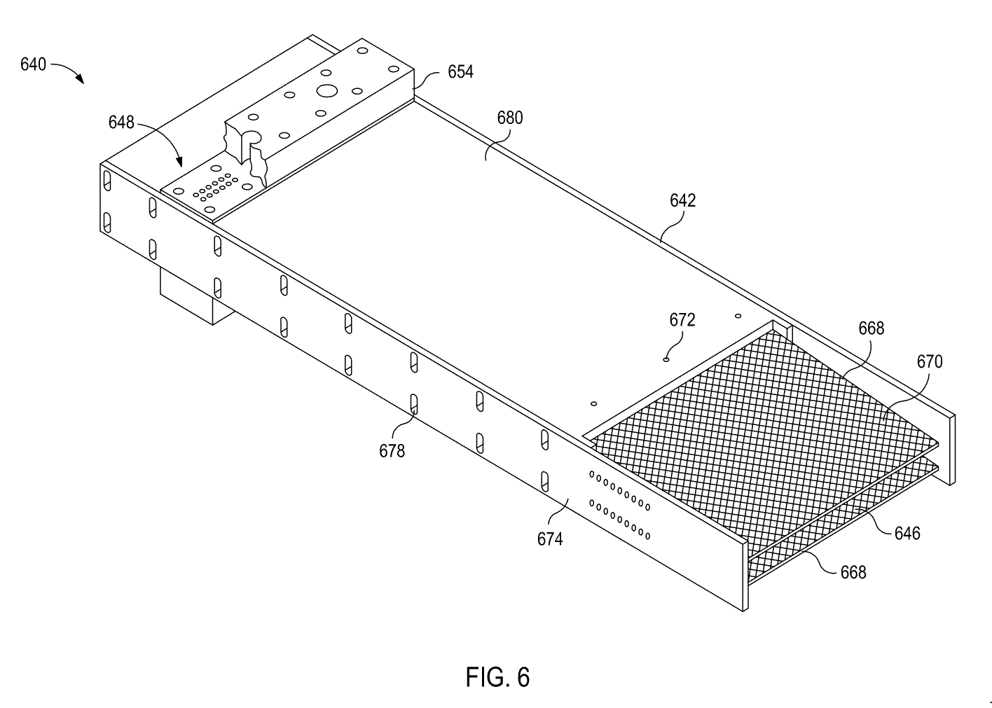

FIGS. 5A-C provide illustrations of nonlimiting examples of heated collectors 520 of the present invention with inlet 522 and outlet 524, where FIG. 5A is in a generally rectangular configuration, FIG. 5B is a rectangular configuration with a funnel near inlet 522, and FIG. 5C is cylindrical. Additionally, FIG. 6 illustrates a more complex collector (described in detail in U.S. patent application Ser. No. 13/297,716 entitled “Nonwoven Materials from Polymer Melt Filaments and Apparatuses and Methods Thereof” filed on Nov. 16, 2011, the entire disclosure of which is incorporated herein by reference) that may be heated so as to provide a heated collector. In these examples of heated collectors, any wall or portion thereof may be heated to produce the skin of the in situ core/skin nonwoven materials of the present invention.

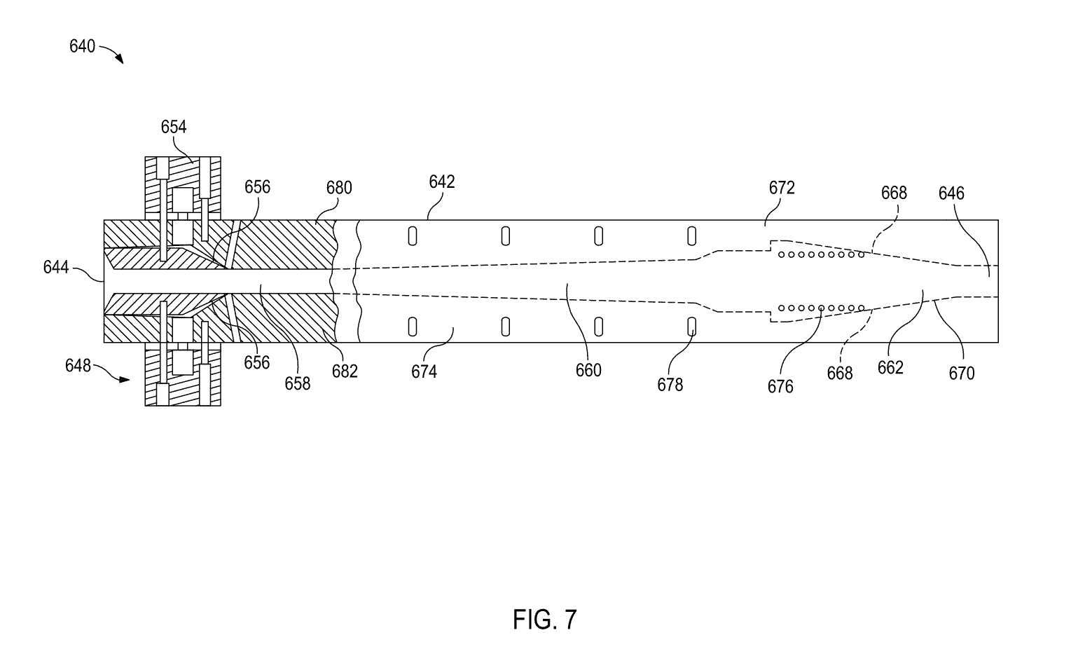

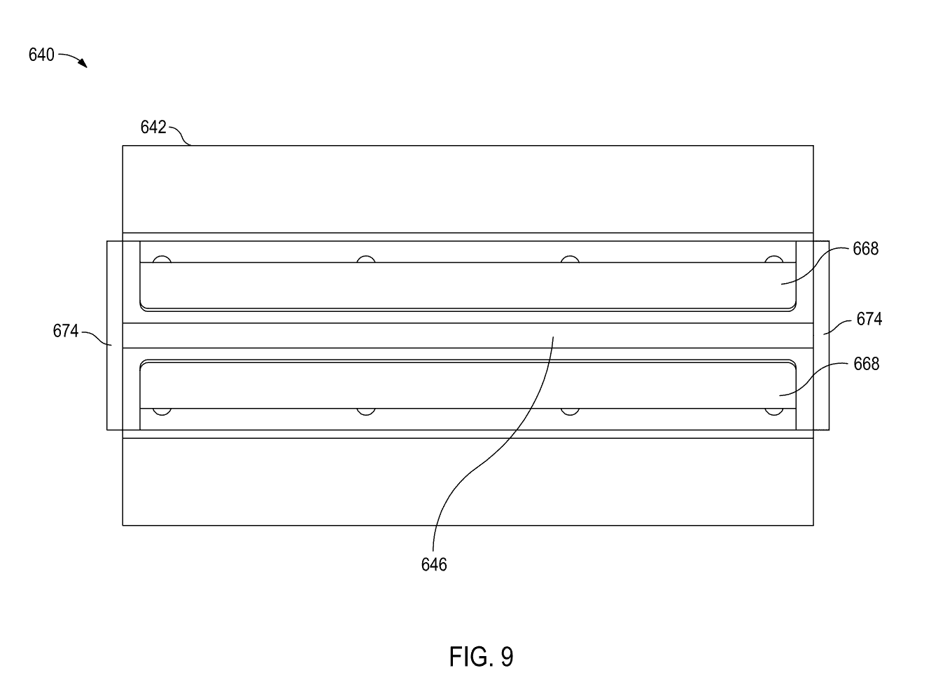

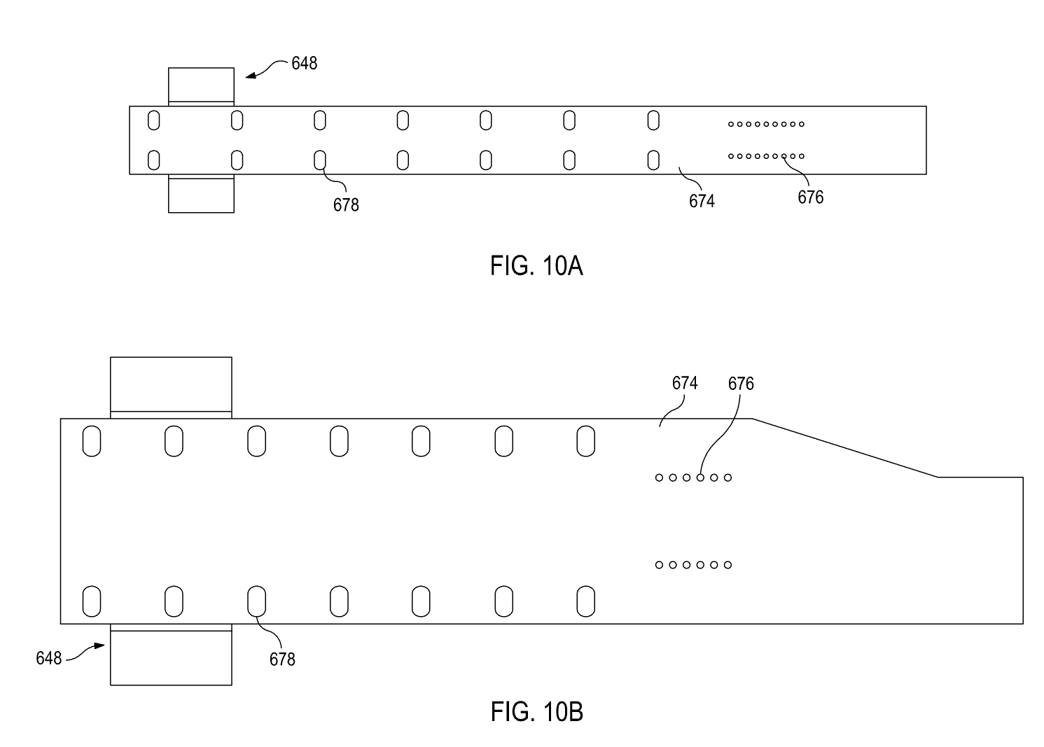

It should be noted that the use of the more complex collector illustrated in FIG. 6 may allow for the in situ core/skin nonwoven material of the present invention to be formed by passing polymer melt filaments through the collector with the use of a Venturi flow. The use of a Venturi flow to move the in situ core/skin nonwoven material through the collector may depend on, inter alia, the skin thickness and Venturi flow rates. Details of the heated collector illustrated in FIG. 6 are provided below with FIGS. 7-14.

In some embodiments, a heated collector may be configured with an inlet and/or an outlet independently having a suitable cross-sectional shape, e.g., circular (for example as shown in FIG. 5C), substantially circular, ovular, substantially ovular, square, rectangular (for example as shown in FIGS. 5A-B), polyagonal, polyagonal with rounded corners, or any hybrid thereof.

In some embodiments, a heated collector may be configured to have an inlet with a dimension in at least one direction (e.g., width, height, or diameter) ranging from about 0.5 cm, 1 cm, 5 cm, or 25 cm to about 10 m, 5 m, 1 m, or 100 cm, and wherein the inlet size may range from any lower limit to any upper limit and encompass any subset therebetween.

In some embodiments, a heated collector may be configured to have an outlet with a dimension in at least one direction (e.g., width, height, or diameter) ranging from about 0.5 cm, 1 cm, 5 cm, or 25 cm to about 10 m, 5 m, 1 m, or 100 cm, and wherein the outlet size may range from any lower limit to any upper limit and encompass any subset therebetween.

In some embodiments, the heated collector of the present invention may be designed to be resized, e.g., the inlet, the outlet, and/or the enclosure of the heated collector. Resizable heated collectors may advantageously allow for adjusting the size of the heated collector, which may allow for a single apparatus to be configured to produce a plurality of sizes of in situ core/skin nonwoven materials of the present invention. Additionally, if resizing is done on-the-fly the size of the in situ core/skin nonwoven material produced therefrom may consequently be adjusted on-the-fly. Further, resizable headed collectors may provide for starting the extrusion of the polymer melt filaments and assisting with the initial formation of the in situ core/skin nonwoven material and its passage through the heated collector.

In some embodiments, a heated collector may have an inlet and an outlet with a different size and/or cross-sectional shape, e.g., as shown in FIG. 5B.

One skilled in the art, with the benefit of this disclosure, should understand the plurality of designs by which heated collectors of the present invention may be configured to be sizable, e.g., with hinges, set-screws, and the like.

Suitable elevated temperatures for walls may be at or above the softening temperature of the composition of the polymer melt filaments. As used herein, the term “softening temperature,” and derivatives thereof, refers to the temperature above which a material becomes pliable, which is typically below the melting point of the material, e.g., the polymer composition of the polymer melt filaments. In some embodiments of the present invention, walls or portions thereof of heated collectors of the present invention may be at a temperature ranging from a lower limit of about 50° C., 75° C., 100° C., or about 150° C. to an upper limit of about 400° C., 350° C., 300° C., 250° C., or 200° C., and wherein the temperature may range from any lower limit to any upper limit and encompass any subset therebetween.

Some embodiments may involve heating the desired walls or portions thereof of heated collectors of the present invention. Heat may be radiant heat, conductive heat, convective heat, or any combination thereof. Heating may involve thermal sources including, but not limited to, heated fluids flowing through the walls or portions thereof, heated fluids external to the heated collector in thermal communication with the walls or portions thereof, ovens in thermal communication with the walls or portions thereof, furnaces in thermal communication with the walls or portions thereof, flames in thermal communication with the walls or portions thereof, thermoelectric heating materials in thermal communication with the walls or portions thereof, and the like, or any combination thereof. By way of nonlimiting example, heating may involve passing heated air, nitrogen, or other gas through a series of channels within the walls or portions thereof. Another nonlimiting example may involve walls or portions thereof made of thermoelectric materials capable of reaching a desired temperature. In yet other embodiments when polymer melt filaments are formed using heated gasses, the heated gas may pass through the heated collector so as to be the primary source of heat to the walls of the heated collector.

Some embodiments may involve passing heated air from the formation of the polymer melt filaments through the heated collector while cooling at least some of the walls of the heated collector so as to mitigate skin formation along the cooled walls. Cooling may involve thermal sources including, but not limited to, cooled fluids flowing through the walls or portions thereof, cooled fluids external to the heated collector in thermal communication with the walls or portions thereof, chillers in thermal communication with the walls or portions thereof, thermoelectric cooling materials in thermal communication with the walls or portions thereof, and the like, or any combination thereof.

Some embodiments may involve monitoring and/or adjusting the temperature of the walls or portions thereof of the heated collectors of the present invention. One skilled in the art, with the benefit of this disclosures, should understand the plurality of methods, apparatuses, and devices for monitoring and/or adjusting the temperature of the walls or portions thereof of the heated collectors of the present invention so as to achieve production of the desired in situ core/skin nonwoven material of the present invention.

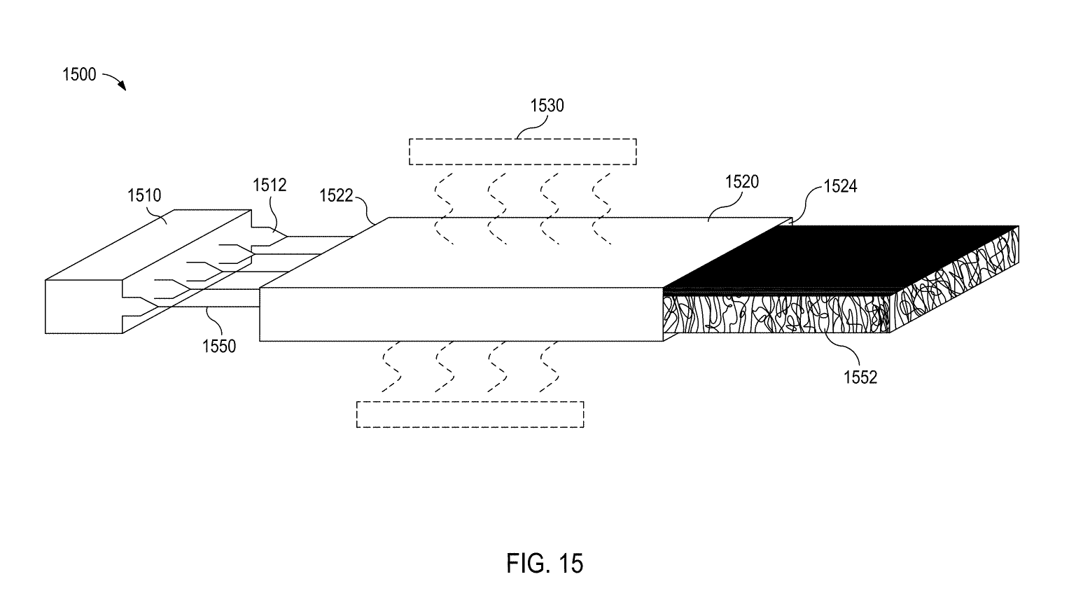

FIG. 15 provides an illustration of a nonlimiting example of a system of the present invention for forming in situ core/skin nonwoven materials of the present invention. System 1500 includes polymer melt extruder 1510 with a plurality of dies 1512, heated collector 1520 with inlet 1522 and outlet 1524, and heater 1530 in thermal communication with heated collector 1520. Heated collector 1520 is configured to receive polymer melt filaments 1550 from dies 1512 and produce in situ core/skin nonwoven material 1552. As shown in FIG. 15, heaters 1530 are in thermal communication with the top and bottom of heated collector 1520 so as to produce in situ core/skin nonwoven material 1552 with a core having a skin on the top and the bottom.

In some embodiments, systems of the present invention may comprise at least one polymer melt extruder having a plurality of dies and a heated collector in operable communication with the dies so as to receive polymer melt filaments therefrom. One skilled in the art with the benefit of this disclosure should understand the necessary configurations and/or additional devices necessary in addition to an extruder having a plurality of dies in order to form a plurality of desired polymer melt filaments, e.g., spunbond filaments, meltblown filaments, and electrospun filaments. Further, one skilled in the art with the benefit of this disclosure should understand that various die configurations may be utilized, e.g., knife-edge type dies, annular dies, melt-blowing dies, extrusion dies, slot dies, any hybrid thereof, or any combination thereof. By way of nonlimiting example, systems of the present invention may further comprise extruding polymer melt filaments to a moving filament collector screen where there is a charge difference between the die and the filament collector screen and then transporting the polymer melt filaments to a heated collector of the present invention. By way of another nonlimiting example, systems of the present invention may further comprise attenuators between the extruder and the heated collector so as to attenuate the diameter of the polymer melt filaments before introduction into the heated collector.

In some embodiments, forming the in situ core/skin nonwoven materials of the present invention may involve passing polymer melt filaments into a heated collector comprising a stop, allowing a starter section to form, moving (or removing) the stop (or barrier), allowing the polymer melt filaments to then continuously produce an in situ core/skin nonwoven material of the present invention. In some embodiments, a stop may be integral to the heated collector of the present invention. In some embodiments, a stop may be separate from the heated collector.

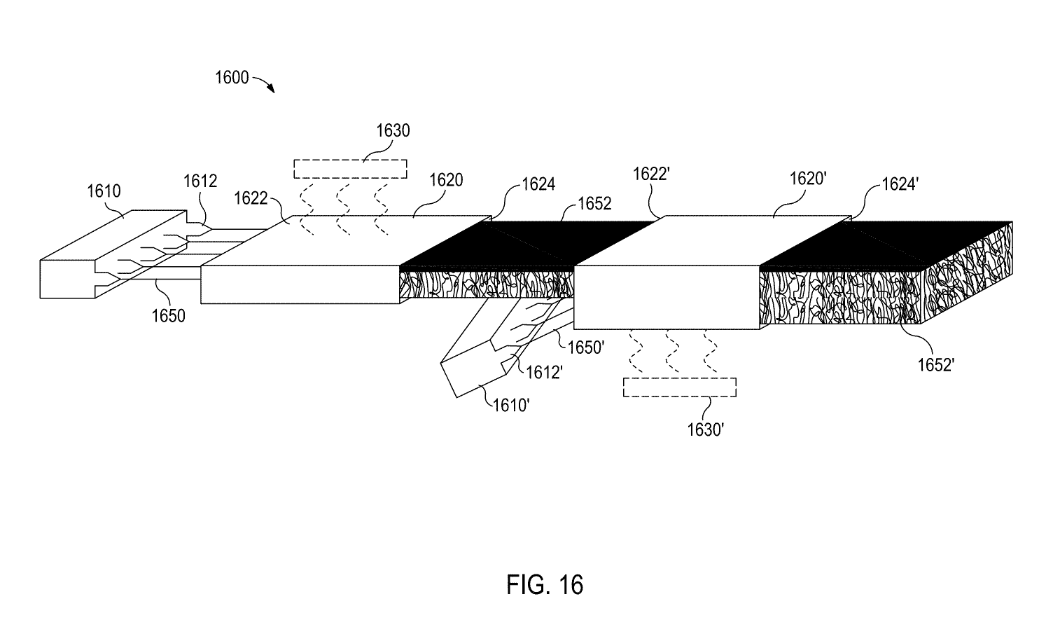

In some embodiments, systems of the present invention may have two or more heated collectors in series. FIG. 16 provides an illustration of a nonlimiting example of a system of the present invention having two heated collectors in series. System 1600 includes first polymer melt extruder 1610 with a plurality of dies 1612, first heated collector 1620 with inlet 1622 and outlet 1624, first heater 1630 in thermal communication with first heated collector 1620, second polymer melt extruder 1610′ with a plurality of dies 1612′, second heated collector 1620′ with inlet 1622′ and outlet 1624′, and second heater 1630′ in thermal communication with second heated collector 1620′. First heated collector 1620 is configured to receive polymer melt filaments 1650 from dies 1612 and produce in situ core/skin nonwoven material 1652. As shown in FIG. 16, first heater 1630 is in thermal communication with the top of first heated collector 1620 so as to produce in situ core/skin nonwoven material 1652 with a core having a skin on the top. Second heated collector 1620′ is configured to receive in situ core/skin nonwoven material 1652 and polymer melt filaments 1650′ from dies 1612′ and produce in situ core/skin nonwoven material 1652′. As shown in FIG. 16, second heater 1630′ is in thermal communication with the bottom of second heated collector 1620′ so as to produce in situ core/skin nonwoven material 1652′ with a core having a skin on the bottom and the skin on the top as produced in first heated collector 1620.

In some embodiments, systems of the present invention may optionally include apparatuses and/or machinery that may assist with ensuring the second (or greater) heated collector not create too much tension on the in situ core/skin nonwoven material so as to hinder the proper operation of a previous heated collector. By way of a nonlimiting example, tension rollers may be used for proper transfer of an in situ core/skin nonwoven material between heated collectors.

In some embodiments, systems of the present invention may produce in situ core/skin nonwoven materials of the present invention that are then transported to other areas for storage or further processing. Examples of further processing areas may include, but are not limited to, adhesion areas, product production areas, and the like, or any combination thereof. Laminating areas may provide for, inter alia, lamination of in situ core/skin nonwoven materials of the present invention to other nonwoven materials (of the present invention or otherwise), woven materials, and the like, or any combination thereof. Product production areas may provide for, inter alia, the production of products (examples detailed further herein).

In some embodiments of the present invention, systems for producing in situ core/skin nonwoven materials of the present invention may include at least one additive application area. Suitable additives are described further herein. Additive application areas may be disposed before, along, and/or after extruders having a plurality of dies, heated collectors, optional other apparatuses (e.g., attenuators, heaters, and/or filament screen collectors), product production lines, or any combination thereof. It should be noted that applying includes, but is not limited to, dipping, immersing, submerging, soaking, rinsing, washing, painting, coating, showering, drizzling, spraying, placing, dusting, sprinkling, affixing, and any combination thereof. Further, it should be noted that applying includes, but is not limited to, surface treatments, infusion treatments where the additive incorporates at least partially into filaments, and any combination thereof.

One skilled in the art, with the benefit of this disclosure, will recognize the apparatuses or machinery capable for properly transporting the polymer filaments and in situ core/skin nonwoven materials to, between, and/or from the extruder having a plurality of dies, the heated collector, and any additional processing areas or lines (e.g., collection areas, additive application areas, nonwoven manufacturing lines, product manufacturing lines, and the like). By way of nonlimiting examples, suitable apparatuses and/or machinery may include guides, rollers, reels, gears, conveyors, transfer belts, vacuums, air jets, and the like, any hybrid thereof, or any combination thereof. In some embodiments of the present invention, systems may include a conveyor for transporting in situ core/skin nonwoven materials of the present invention to additional processing areas.

In some embodiments, heated collectors of the present invention may generally comprise an enclosure with at least one wall, an inlet, and an outlet. Optionally, in some embodiments, heated collectors of the present invention may be configured with an inlet having a desired cross-sectional shape, an outlet having a desired cross-sectional shape, an inlet having a desired size, an outlet having a desired size, a sizable inlet, a sizable outlet, a sizable enclosure, a heated inlet, a heated outlet, a heated enclosure, at least a portion of a wall heated, a cooled inlet, a cooled outlet, a cooled enclosure, at least a portion of a wall cooled, on-the-fly temperature adjustment for any component of the heated collector, or any combination thereof.

In some embodiments, systems of the present invention may comprise at least one polymer melt extruder having a plurality of dies and a heated collector in operable communication with the dies so as to receive polymer melt filaments therefrom. Optionally, systems of the present invention may further comprise, individually or in combination, a moving filament collector screen where there is a charge difference between the die and the filament collector screen, attenuators between the extruder and the heated collector so as to attenuate the diameter of the polymer melt filaments before introduction into the heated collector, a second heated collector with apparatuses and/or machinery that may assist with ensuring the second (or greater) heated collector not create too much tension on the in situ core/skin nonwoven material so as to hinder the proper operation of a previous heated collector, collection areas, additive application areas, nonwoven manufacturing lines, adhesion areas, or product production areas.

### IV. Applications

In some embodiments of the present invention, systems may include product production lines capable of converting in situ core/skin nonwoven materials into products. Nonlimiting examples of products that may be made from the in situ core/skin nonwoven materials of the present invention may include hygiene products (e.g., baby diapers, incontinence products, feminine hygiene products), disposable medical products (e.g., gauze, bandages, band-aids, wound pads, orthopedic waddings, stoma products, adhesive plasters, compresses, tapes, wraps, masks, gowns, and shoe covers), insulation products (e.g., for thermal, acoustic, and/or vibration insulation) (e.g., clothing, packs, vehicles, textiles, and noise damping in ceilings and walls), furniture textiles (e.g., upholstery, bedware, and quilted products), sorbents (e.g., for automotive, chemical, emergency responders, or packaging) (e.g., rags, pads, wraps, medical supplies, and oil booms), horticulture products (e.g., covering to protect plants from extreme temperatures at night or day), tapes for use with cables (e.g., for water-blocking, electrically conductivity, or thermal barriers), composite materials (e.g., glass-fiber-reinforced plastics), surfacing products (e.g., pipes, tanks, container boards, faøade panels, skis, surfboards, and boats), window treatments, shoe inserts (e.g., liners, counterliners, interliners, and reinforcing materials), the inside layer of tufted carpets and carpet tiles, carpet backings, fluid filters (e.g., configured as cartridges, cassettes, bags, sheets, mats, screens, and films) (e.g., milk filters, coolant filters, metal-processing filters, blood plasma filters, frying fat filters, drinking water filters, enzyme filters, vacuum filters, kitchen hood filters, respirator filters, appliance filters, furnace filters, high-temperature filters, activated carbon filters, and pocket filters), low density abrasives (e.g., hand pads, wipes, sponge laminates, floor pads, brushes, wools, wheels, and belts), polishing pads (e.g., for use in manufacturing semiconductor wafers, memory discs, precision optics, and metallurgical components), vehicle interiors (e.g., headliners, trunkliners, door trim, package trays, sunvisors, and seats), containers (e.g., bags), and the like.

By way of nonlimiting example, an in situ core/skin nonwoven material of the present invention may be used as an oil boom or component thereof. A heated collector of the present invention may be used to yield, for example, a circular in situ core/skin nonwoven material of the present invention having a skin about a core. The polymer melt filaments and any additives thereto of the in situ core/skin nonwoven material may be chosen such that a desired level of oil absorbency is achieved.

By way of another nonlimiting example, an in situ core/skin nonwoven material of the present invention may be used in absorbent mats. A heated collector of the present invention may be used to yield a low caliper, flat in situ core/skin nonwoven material of the present invention having a skin on both the top and bottom, and optionally sides, of the core. The polymer melt filaments and any additives thereto of the in situ core/skin nonwoven material may be chosen such that a desired level of oil or water absorbency is achieved, e.g., polypropylene and/or ethylene vinyl acetate copolymer for oil absorbency or cellulose acetate and/or cellulose triacetate for water absorbency.

By way of yet another nonlimiting example, an in situ core/skin nonwoven material of the present invention may be used as a fluid filter or component thereof. A heated collector of the present invention may be used to yield, for example, a flat in situ core/skin nonwoven material of the present invention having a skin on either the top and/or the bottom of a core. This in situ core/skin nonwoven material design allows for large particulate filtration through the core portion and finer particulate filtration through the skin portion.

Alternatively, this fluid filter may be used for the coalescence of a mist and/or precipitation of aerosols, which may be applicable in the crankcase ventilation of diesel engines, for example. Again the polymer melt filaments and additives thereto of the in situ core/skin nonwoven material may be chosen such that a desired level of chemical compatibility is achieved, e.g., organic solvent filters or water-wettable filters.

By way of another nonlimiting example, an in situ core/skin nonwoven material of the present invention may be used as an air filter, where the skin advantageously provides for a self-supporting structure. A heated collector of the present invention may be used to yield, for example, a flat in situ core/skin nonwoven material of the present invention with an appropriate caliper and skin on the top and/or bottom. The polymer melt filaments and additives thereto of the in situ core/skin nonwoven material may be chosen such that the desired pollutants may be filtered from the air passing therethrough. Further the density distribution across the direction through which the air will be filtered may be engineered so as to provide varying levels of filtration across the filtration direction, e.g., an in situ core/skin nonwoven material having a cross-section similar to that illustrated in FIG. 2C where skin is present on only one side, i.e., along the bottom, may allow for filtration of larger particles as the air passes through the core and then smaller particles at the skin level. In a similar example with skin also along the caliper of the in situ core/skin nonwoven material, the skin along the caliper may provide structural support such that a traditional air filter frame is not needed.

By way of yet another nonlimiting example, an in situ core/skin nonwoven material of the present invention may be useful as a pre-filter for air filtration or air-cleaning systems, e.g., in vehicle engines. Further, the substructure, e.g., corrugation, of the core may enhance pre-filtration applications.

In another nonlimiting example, an in situ core/skin nonwoven material of the present invention may be useful in acoustic insulation cars. Such an in situ core/skin nonwoven material may, for example, have a caliper of about 0.5 cm to about 3 cm and a skin on at least one side, e.g., as shown in FIG. 2C.

In yet another nonlimiting example, an in situ core/skin nonwoven material of the present invention may be useful in thermal insulation, e.g., for homes. Such an in situ core/skin nonwoven material may, for example, have a structure similar to traditional fiberglass insulation for use in homes with a very high caliper and a skin on one side to provide structural support and easy handling (e.g., for rolling). However, advantageously with the methods of the present invention such an in situ core/skin nonwoven material may be produced with fewer steps because the skin in the caliper may be produced in situ.

V. Heated Collector with Venturi Flow Capabilities

Generally, a system of the present invention may include at least one die operably connected to a heated collector. Referring now to FIGS. 6-14, nonlimiting examples of heated collectors of the present invention with Venturi flow capabilities and components thereof, heated collector 640 may include housing 642 that generally is formed by a pair of side plates 674, top plate 680, and bottom plate 682. It should be noted that side, top, and bottom to modify the plates are used for simplicity in describing the heated collector and should not be taken to be limiting as to the relation of the heated collector to the plane of the ground. The pair of side plates 674 may be operably attached to the top plate 680 and bottom plate 682 with bolts at sizing guides 678.

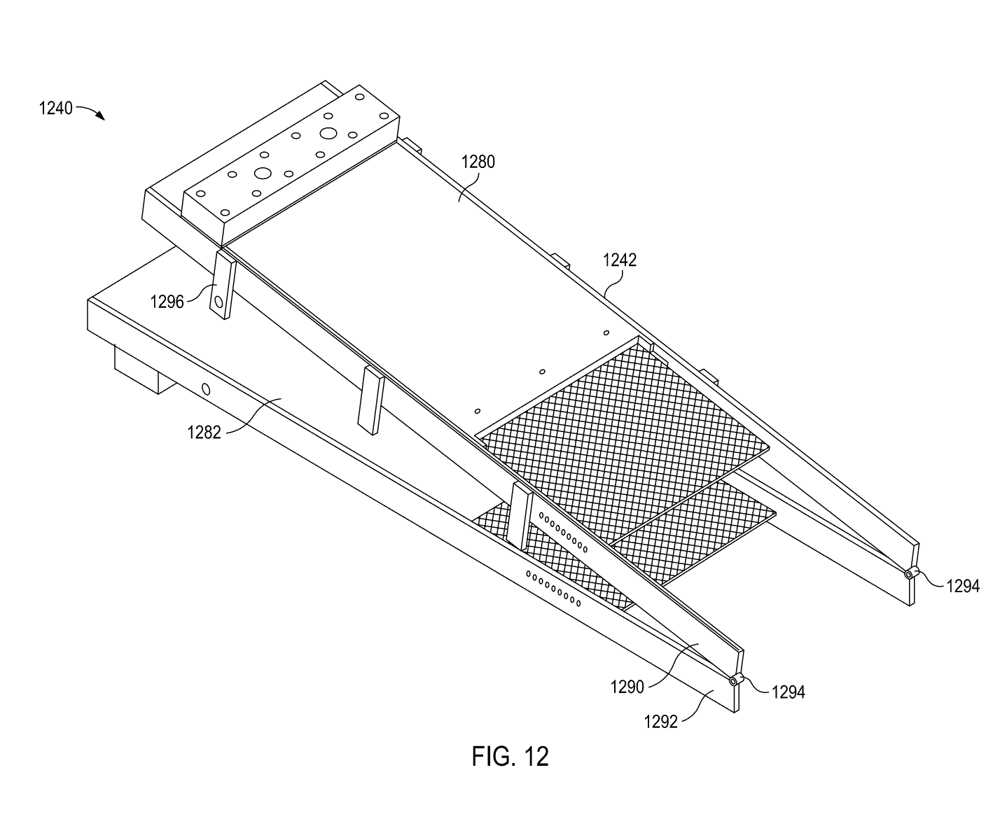

At one end, heated collector 640 includes inlet opening 644. As best seen as an example in FIG. 12, inlet opening 644 may have a generally rectangular configuration that corresponds generally to the shape and size of the dies that from the polymer melt filaments which is received in inlet opening 644. Housing 642 also includes outlet opening 646 which, as best seen in FIG. 6, may also have a rectangular configuration that corresponds to the desired shape of the in situ core/skin nonwoven material leaving heated collector 640.

Air jet 648 may be formed adjacent the inlet end of housing 642 and may include a source of compressed air (or other fluid in some embodiments) and a conventional control valve for regulating the flow of compressed air from the compressed air source to air manifold 654 through which the compressed air is delivered to jet orifices 656. Jet orifices 656 may form a conventional jet of air for moving the polymer melt filaments through central passageway 658 in housing 642 as will be explained in greater detail herein. As best seen in FIG. 7, passageway 658 has a gradually increasing cross-sectional area in the direction of movement of the polymer melt filaments so as to provide forming chamber 660 downstream of air jet 648. Forming chamber 660 may also preferably have a generally rectangular configuration that corresponds to the rectangular shape of the in situ nonwoven material.

Accumulating chamber 662 may be located adjacent the outlet end of housing 642 and downstream of forming chamber 660 and may have a vertical dimension which is greater than outlet opening 646 of forming chamber 660.

Accumulating chamber 662 may also be preferably formed with a rectangular configuration to permit the polymer melt filaments to pass into accumulating chamber 662 from forming chamber 660 to accumulate within accumulating chamber 662. Ultimately the polymer melt filaments may be passed from housing 642 through outlet opening 646 at different flow rates yielding different in situ nonwoven materials.

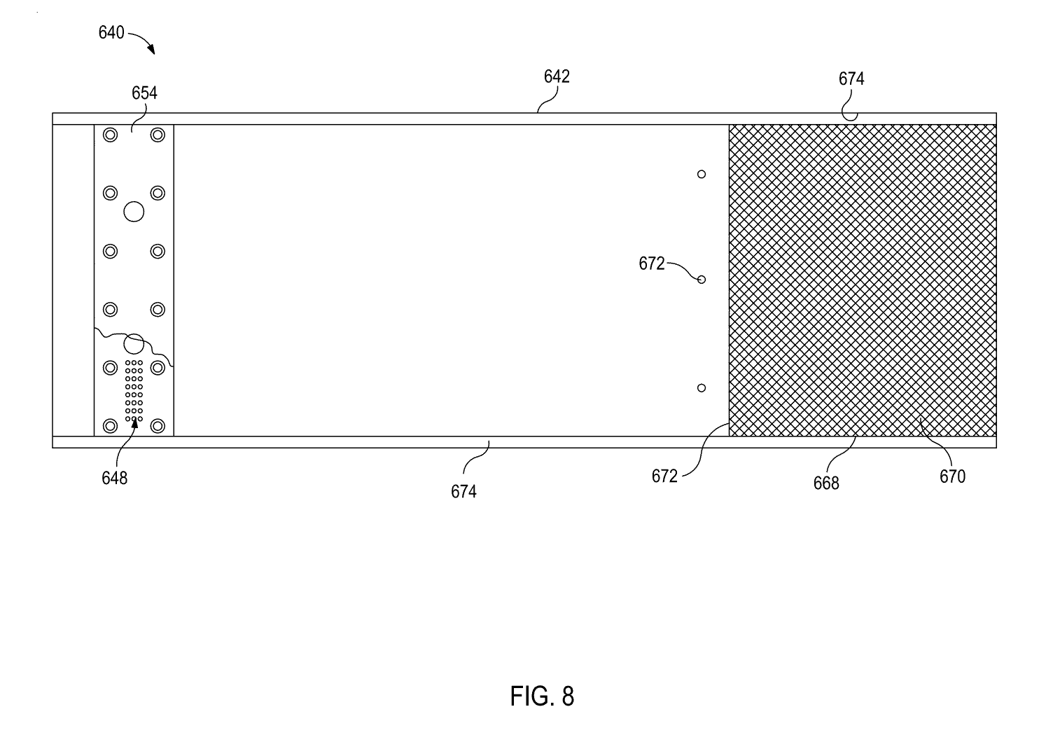

As best seen in FIGS. 7 and 8, a pair of perforated plates 668, each having a large number of perforations 670 therein, may be disposed in accumulating chamber 662 and in side plates 674 between forming chamber 660 and accumulating chamber 662. Perforated plates 668 may be fixed in place to top plate 680 and bottom plate 682 by a plurality of bolts 672 that maintain perforated plates 668 in fixed positions to form accumulating chamber 662.

The size of forming chamber 660 and accumulating chamber 662 may be involved in determining the caliper of the acquisition distribution layer produced from heated collector 640. Sizing guides 678 along side plates 674 allow for increasing or decreasing the size of forming chamber 660. It should be noted that the configuration of sizing guides 678 along side pates 674 may allow for changing the size of forming chamber 660 by different amounts by angling top plate 680 relative to bottom plate 682. Varying the shape and/or positions of perforated plates 668 the size of accumulating chamber 662 may be varied.

Similarly, the size of inlet opening 644 and outlet opening 646 may be adjusted using sizing guides 678 along side plates 674 or varying the position and/or shape of perforated plates 668. Variable sizing of inlet opening 644 may advantageously allow for receiving polymer melt filaments from dies with different configuration into heated collector 640. Also variable sizing of outlet opening 646 may advantageously allow for producing higher caliper in situ core/skin nonwoven materials.

Side plates 674 may also have a plurality of perforations 676 located generally at a position where the carrier air leaves forming chamber 660 and enters accumulating chamber 662, whereby some of the carrier air can be discharged through perforations 676.

In the operation of heated collector 640, compressed air flows to air jet 648 at a flow rate controlled by the control valve, and the jet of air formed by orifices 656 may move the polymer melt filaments through forming chamber 660. As the polymer melt filaments move through forming chamber 660 by the carrier air, the carrier air may at least partially bulk the in situ nonwoven material.

While some of the carrier air may be discharged through perforations 676 in side plates 674, a substantial portion of the carrier air may move the polymer melt filaments through the spacing between perforated plates 668 and passes outwardly through perforations 670 in perforated plates 668. In so doing, the air passing outwardly through perforations 670 urges the polymer melt filaments into frictional engagement with the facing inner surfaces of perforated plates 668. This frictional engagement may create a braking action on the polymer melt filaments which should retard the movement of the polymer melt filaments through accumulating chamber 662 and causes the polymer melt filaments to accumulate in accumulating chamber 662, after which the bulked and densified polymer melt filaments exit the accumulating chamber 662 as an in situ nonwoven material through the outlet opening 646 at different flow rates.

The flow rate of the carrier air may determine the retarding or braking action applied to the polymer melt filaments as they pass between perforated plates 668. If the flow rate of the carrier air is increased, the carrier air passing outwardly through perforations 670 in perforated plates 668 will urge the polymer melt filaments into engagement with perforated plates 668 with a greater force, and may thereby increase the retarding or braking action that is applied to the polymer melt filaments. Conversely, if the flow rate of the carrier air is decreased, there will be a smaller braking action applied to the polymer melt filaments. Therefore, virtually infinite regulation of the braking action may be obtained by the simple expedient of operating the control valve to provide a flow of carrier air that provides the desired braking action imposed on the polymer melt filaments, and thereby should control the density and caliper of the acquisition distribution layer as it leaves housing 642.

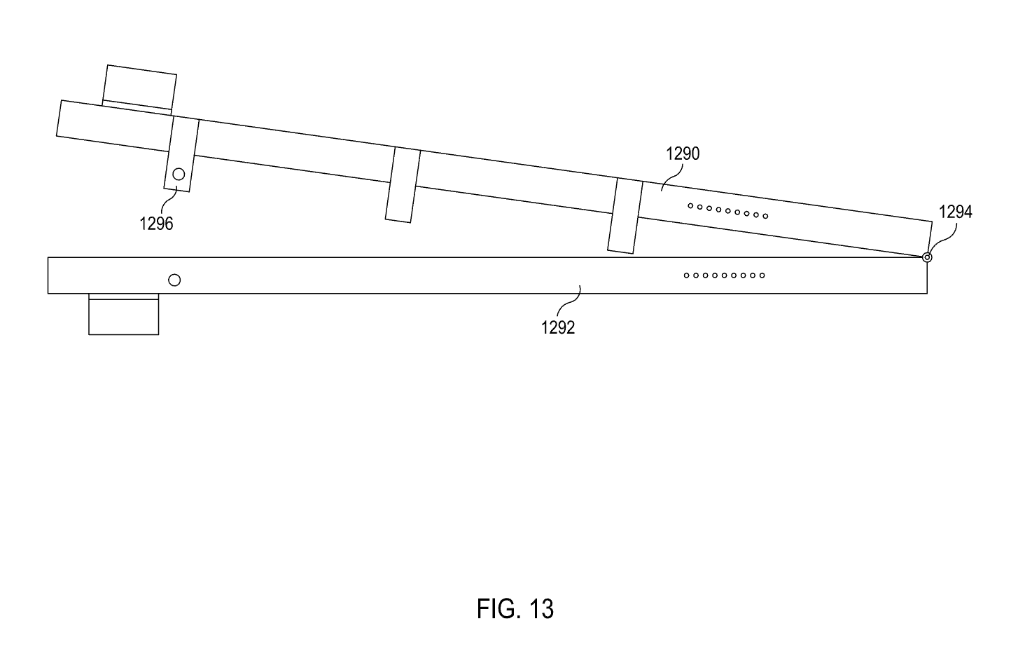

In some embodiments, heated collectors of the present invention with Venturi flow capabilities may have hinged side plates. Referring now to FIGS. 12-13, nonlimiting examples of heated collectors of the present invention with Venturi flow capabilities and components thereof, heated collector 1240 may have a pair of hinged side plates having side plate top half 1290 and side plate bottom half 1292, and side plate hinge 1294. Housing 1242 may be generally formed by top plate 1280 operably attached to side plate top half 1290 and bottom plate 1282 operably attached to side plate bottom half 1292. It should be noted that side, top, and bottom to modify the plates (or components thereof) are used for simplicity in describing the heated collector and should not be taken to be limiting as to the relation of the heated collector to the plane of the ground.

The side plates may have side plate guides 1296 operably attached to either side plate top half 1290 and side plate bottom half 1292 (not shown) to ensure proper alignment when the side plates are closed. To keep the side plate halves 1290 and 1292 closed during operation, at least one side plate guide 1296 may be capable of operably attaching to both side plate halves 1290 and 1292. As shown in FIGS. 12-13, one side plate guide 1296 is attached to side plate top half 1290 and has a hole that lines up with a threaded hole in side plate bottom half 1292 allowing for a bolt to secure side plate halves 1290 and 1292 in the closed position.

One skilled in the art should recognize the plurality of modifications to hinged side plates that achieve the same function of the heated collector, e.g., side plate halves with grooves rather than side plate guides to ensure proper alignment. Further, one skilled in the art should recognize that during operation polymer melt filaments passing through the heated collector may snag on some imperfections (e.g., burs or gaps) in the side plates, especially at high air jet speeds.

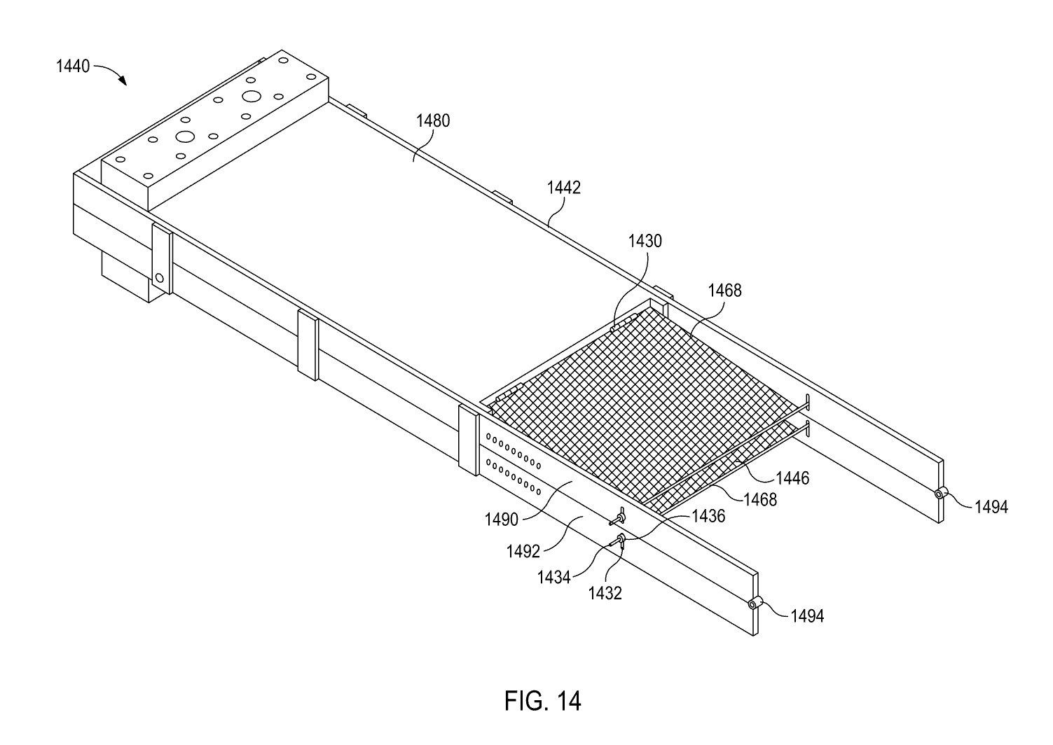

In some embodiments, heated collectors of the present invention with Venturi flow capabilities may have a sizeable outlet opening. Referring now to FIG. 14, a nonlimiting example of a heated collector of the present invention with Venturi flow capabilities and components thereof, heated collector 1440 may include housing 1442 that generally is formed by a pair of side plates having side plate top half 1490 and side plate bottom half 1492 with side plate hinge 1494; top plate 1480 operably attached to side plate top half 1490, and bottom plate 1482 (not shown) operably attached to side plate bottom half 1492. Accumulating chamber 1462 (not shown) is formed by a pair of perforated plates 1468 fixed in place to top plate 1480 and bottom plate 1482 by hinges 1430 that allow for sizing outlet 1446 by fixing perforated plates 1468 into position by securing perforated plate sizing rods 1434 in outlet sizing guides 1432 with nut 1436.

One skilled in the art should recognize the plurality of modifications to hinged perforated plates that achieve the same function of the heated collector having Venturi flow capabilities, e.g., vertical screws to adjust the location of the perforated plates and consequently the size of the outlet opening on the fly. One skilled in the art should recognize the modifications should maintain the intended purpose of the perforated plates, i.e., provide a brake for the polymer melt filaments passing therethrough so as to create the bulk of the subsequent in situ core/skin nonwoven material.

In some embodiments, heated collectors of the present invention, whether they include Venturi flow capabilities or otherwise, may have any combination of the features including, but not limited to, adjustable side plates, hinged side plates, a sizeable inlet opening, and a sizeable outlet opening. In some embodiments, the present invention provides a heated collector that comprises an inlet opening to a central passageway, the inlet opening having a width of about 5 cm to about 10 m and a height of about 0.5 cm to about 5 cm; an air jet capable of forming a Venturi in a central passageway; a forming chamber along the central passageway disposed after the air jet; an accumulation chamber formed by at least two perforated plates and at least two side plates, the accumulation chamber being disposed along the central passageway after the forming chamber; and an outlet opening to the central passageway, the outlet opening having a width of about 5 cm to about 10 m and a height of about 2 mm to about 500 mm. In some embodiments said heated collector may have a sizeable inlet opening and/or a sizeable outlet opening.

### VI. Additives

Some embodiments may involve applying additives to polymer melt filaments, the in situ core/skin nonwoven materials of the present invention, products therefrom, or any combination thereof. Suitable additives for use in conjunction with the present invention may include, but not be limited to, active particles, active compounds, ion exchange resins, superabsorbent polymers, zeolites, nanoparticles, ceramic particles, abrasive particulates, absorbent particulates, softening agents, plasticizers, pigments, dyes, flavorants, aromas, controlled release vesicles, binders, adhesives, tackifiers, surface modification agents, lubricating agents, emulsifiers, vitamins, peroxides, biocides, antifungals, antimicrobials, deodorizers, antistatic agents, flame retardants, antifoaming agents, degradation agents, conductivity modifying agents, stabilizing agents, or any combination thereof. Said additives are detailed further herein.

Active particles for use in conjunction with the present invention may be useful in actively reducing components from a fluid stream by absorption or reaction. Suitable active particles for use in conjunction with the present invention may include, but not be limited to, nano-scaled carbon particles, carbon nanotubes having at least one wall, carbon nanohorns, bamboo-like carbon nanostructures, fullerenes, fullerene aggregates, graphene, few layer graphene, oxidized graphene, iron oxide nanoparticles, nanoparticles, metal nanoparticles, gold nanoparticles, silver nanoparticles, metal oxide nanoparticles, alumina nanoparticles, magnetic nanoparticles, paramagnetic nanoparticles, superparamagnetic nanoparticles, gadolinium oxide nanoparticles, hematite nanoparticles, magnetite nanoparticles, gado-nanotubes, endofullerenes, Gd@C₆₀, core-shell nanoparticles, onionated nanoparticles, nanoshells, onionated iron oxide nanoparticles, activated carbon, ion exchange resins, desiccants, silicates, molecular sieves, silica gels, activated alumina, zeolites, perlite, sepiolite, Fuller's Earth, magnesium silicate, metal oxides, iron oxides, activated carbon, and any combination thereof.

Suitable active particles for use in conjunction with the present invention may have at least one dimension of about less than one nanometer, such as graphene, to as large as a particle having a diameter of about 5000 nanometers. Active particles for use in conjunction with the present invention may range from a lower size limit in at least one dimension of about: 0.1 nanometers, 0.5 nanometers, 1 nanometer, 10 nanometers, 100 nanometers, 500 nanometers, 1 micron, 5 microns, 10 microns, 50 microns, 100 microns, 150 microns, 200 microns, and 250 microns. The active particles may range from an upper size limit in at least one dimension of about: 5000 microns, 2000 microns, 1000 microns, 900 microns, 700 microns, 500 microns, 400 microns, 300 microns, 250 microns, 200 microns, 150 microns, 100 microns, 50 microns, 10 microns, and 500 nanometers. Any combination of lower limits and upper limits above may be suitable for use in conjunction with the present invention, wherein the selected maximum size is greater than the selected minimum size. In some embodiments, the active particles for use in conjunction with the present invention may be a mixture of particle sizes ranging from the above lower and upper limits. In some embodiments of the present invention, the size of the active particles may be polymodal.

Active compounds for use in conjunction with the present invention may be useful in actively reducing components from a fluid stream by absorption or reaction. Suitable active compounds for use in conjunction with the present invention may include, but not be limited to, malic acid, potassium carbonate, citric acid, tartaric acid, lactic acid, ascorbic acid, polyethyleneimine, cyclodextrin, sodium hydroxide, sulphamic acid, sodium sulphamate, polyvinyl acetate, carboxylated acrylate, or any combination thereof.

Suitable ion exchange resins for use in conjunction with the present invention may include, but not be limited to, polymers with a backbone, such as styrene-divinyl benezene (DVB) copolymer, acrylates, methacrylates, phenol formaldehyde condensates, and epichlorohydrin amine condensates; a plurality of electrically charged functional groups attached to the polymer backbone; or any combination thereof.

As used herein, the term “superabsorbent materials” refers to materials, e.g., polymers, capable of absorbing at least three times their weight of a fluid. Suitable superabsorbent materials for use in conjunction with the present invention may include, but not be limited to, sodium polyacrylate, starch graved copolymers of polyacrylonitriles, polyvinyl alcohol copolymers, cross-linked poly(ethylene oxides), polyacrylamide copolymers, ethylene maleic anhydride copolymers, cross-linked carboxymethylcelluloses, and the like, or any combination thereof. By way of nonlimiting example, superabsorbent materials incorporated into a nonwoven may be useful in chemical spill rags and kits.

Zeolites for use in conjunction with the present invention may include crystalline aluminosilicates having pores, e.g., channels, or cavities of uniform, molecular-sized dimensions. Zeolites may include natural and synthetic materials. Suitable zeolites may include, but not be limited to, zeolite BETA (Na₇(Al₇Si₅₇O₁₂₈) tetragonal), zeolite ZSM-5 (Naₙ(AlₙSi₉₆₋ₙO₁₉₂) 16 H₂O, with n<27), zeolite A, zeolite X, zeolite Y, zeolite K-G, zeolite ZK-5, zeolite ZK-4, mesoporous silicates, SBA-15, MCM-41, MCM48 modified by 3-aminopropylsilyl groups, alumino-phosphates, mesoporous aluminosilicates, other related porous materials (e.g., such as mixed oxide gels), or any combination thereof.

Suitable nanoparticles for use in conjunction with the present invention may include, but not be limited to, nano-scaled carbon particles like carbon nanotubes of any number of walls, carbon nanohorns, bamboo-like carbon nanostructures, fullerenes and fullerene aggregates, and graphene including few layer graphene and oxidized graphene; metal nanoparticles like gold and silver; metal oxide nanoparticles like alumina, silica, and titania; magnetic, paramagnetic, and superparamagentic nanoparticles like gadolinium oxide, various crystal structures of iron oxide like hematite and magnetite, about 12 nm Fe₃O₄, gado-nanotubes, and endofullerenes like Gd@C₆₀; and core-shell and onionated nanoparticles like gold and silver nanoshells, onionated iron oxide, and other nanoparticles or microparticles with an outer shell of any of said materials; and any combination of the foregoing. It should be noted that nanoparticles may include nanorods, nanospheres, nanorices, nanowires, nanostars (like nanotripods and nanotetrapods), hollow nanostructures, hybrid nanostructures that are two or more nanoparticles connected as one, and non-nano particles with nano-coatings or nano-thick walls. It should be further noted that nanoparticles for use in conjunction with the present invention may include the functionalized derivatives of nanoparticles including, but not limited to, nanoparticles that have been functionalized covalently and/or non-covalently, e.g., pi-stacking, physisorption, ionic association, van der Waals association, and the like. Suitable functional groups may include, but not be limited to, moieties comprising amines (1°, 2°, or 3°), amides, carboxylic acids, aldehydes, ketones, ethers, esters, peroxides, silyls, organosilanes, hydrocarbons, aromatic hydrocarbons, and any combination thereof; polymers; chelating agents like ethylenediamine tetra a cetate, diethylenetriaminepentaacetic acid, triglycollamic acid, and a structure comprising a pyrrole ring; and any combination thereof.

Suitable ceramic particles for use in conjunction with the present invention may include, but not be limited to, oxides (e.g., silica, titania, alumina, beryllia, ceria, and zirconia), nonoxides (e.g., carbides, borides, nitrides, and silicides), composites thereof, or any combination thereof. Ceramic particles may be crystalline, non-crystalline, or semi-crystalline.

Suitable softening agents and/or plasticizers for use in conjunction with the present invention may include, but not be limited to, water, glycerol triacetate (triacetin), triethyl citrate, dimethoxy-ethyl phthalate, dimethyl phthalate, diethyl phthalate, methyl phthalyl ethyl glycolate, o-phenyl phenyl-(bis) phenyl phosphate, 1,4-butanediol diacetate, diacetate, dipropionate ester of triethylene glycol, dibutyrate ester of triethylene glycol, dimethoxyethyl phthalate, triethyl citrate, triacetyl glycerin, and the like, any derivative thereof, and any combination thereof. One skilled in the art with the benefit of this disclosure should understand the concentration of plasticizers to use as an additive to the filaments.

As used herein, pigments refer to compounds and/or particles that impart color and are incorporated throughout the filaments. Suitable pigments for use in conjunction with the present invention may include, but not be limited to, titanium dioxide, silicon dioxide, carbon black, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, caramel, fruit or vegetable or spice colorants (e.g., beet powder, beta-carotene, turmeric, paprika), or any combination thereof.

As used herein, dyes refer to compounds and/or particles that impart color and are a surface treatment of the filaments. Suitable dyes for use in conjunction with the present invention may include, but not be limited to, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), and FASTUSOL® dyes (an auxochrome, available from BASF) (e.g., Yellow 3GL, Fastusol C Blue 74L).

Suitable flavorants for use in conjunction with the present invention may include, but not be limited to, organic material (or naturally flavored particles), carriers for natural flavors, carriers for artificial flavors, and any combination thereof. Organic materials (or naturally flavored particles) include, but are not limited to, tobacco, cloves (e.g., ground cloves and clove flowers), cocoa, and the like. Natural and artificial flavors may include, but are not limited to, menthol, cloves, cherry, chocolate, orange, mint, mango, vanilla, cinnamon, tobacco, and the like. Such flavors may be provided by menthol, anethole (licorice), anisole, limonene (citrus), eugenol (clove), and the like, or any combination thereof. In some embodiments, more than one flavorant may be used including any combination of the flavorants provided herein.

Suitable aromas for use in conjunction with the present invention may include, but not be limited to, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, cinnamaldehyde, ethyl maltol, vanilla, anisole, anethole, estragole, thymol, furaneol, methanol, or any combination thereof.

Suitable binders for use in conjunction with the present invention may include, but not be limited to, polyolefins, polyesters, polyamides (or nylons), polyacrylics, polystyrenes, polyvinyls, polytetrafluoroethylene (PTFE), polyether ether ketone (PEEK), any copolymer thereof, any derivative thereof, and any combination thereof. Non-fibrous plasticized cellulose derivatives may also be suitable for use as binder particles in the present invention. Examples of suitable polyolefins may include, but not be limited to, polyethylene, polypropylene, polybutylene, polymethylpentene, and the like, any copolymer thereof, any derivative thereof, and any combination thereof. Examples of suitable polyethylenes may include, but not be limited to, ultrahigh molecular weight polyethylene, very high molecular weight polyethylene, high molecular weight polyethylene, low-density polyethylene, linear low-density polyethylene, high-density polyethylene, and the like, any copolymer thereof, any derivative thereof, and any combination thereof. Examples of suitable polyesters may include, but not be limited to, polyethylene terephthalate, polybutylene terephthalate, polycyclohexylene dimethylene terephthalate, polytrimethylene terephthalate, and the like, any copolymer thereof, any derivative thereof, and any combination thereof. Examples of suitable polyacrylics may include, but not be limited to, polymethyl methacrylate, and the like, any copolymer thereof, any derivative thereof, and any combination thereof. Examples of suitable polystyrenes may include, but not be limited to, polystyrene, acrylonitrile-butadiene-styrene, styrene-acrylonitrile, styrene-butadiene, styrene-maleic anhydride, and the like, any copolymer thereof, any derivative thereof, and any combination thereof. Examples of suitable polyvinyls may include, but not be limited to, ethylene vinyl acetate, ethylene vinyl alcohol, polyvinyl chloride, and the like, any copolymer thereof, any derivative thereof, and any combination thereof. Examples of suitable cellulosics may include, but not be limited to, cellulose esters, modified cellulose esters (e.g., sulfate derivatives of a cellulose ester), cellulose acetate, cellulose acetate butyrate, plasticized cellulosics, cellulose propionate, ethyl cellulose, and the like, any copolymer thereof, any derivative thereof, and any combination thereof. In some embodiments, binder particles may comprise any copolymer, any derivative, or any combination of the above listed binders. Further, binder particles may be impregnated with and/or coated with any combination of additives disclosed herein.

Suitable tackifiers for use in conjunction with the present invention may include, but not be limited to, methylcellulose, ethylcellulose, hydroxyethylcellulose, carboxy methylcellulose, carboxy ethylcellulose, water-soluble cellulose acetate, amides, diamines, polyesters, polycarbonates, silyl-modified polyamide compounds, polycarbamates, urethanes, natural resins, shellacs, acrylic acid polymers, 2-ethylhexylacrylate, acrylic acid ester polymers, acrylic acid derivative polymers, acrylic acid homopolymers, anacrylic acid ester homopolymers, poly(methyl acrylate), poly(butyl acrylate), poly(2-ethylhexyl acrylate), acrylic acid ester co-polymers, methacrylic acid derivative polymers, methacrylic acid homopolymers, methacrylic acid ester homopolymers, poly(methyl methacrylate), poly(butyl methacrylate), poly(2-ethylhexyl methacrylate), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, benzyl coco di-(hydroxyethyl) quaternary amines, p-T-amyl-phenols condensed with formaldehyde, dialkyl amino alkyl (meth)acrylates, acrylamides, N-(dialkyl amino alkyl) acrylamide, methacrylamides, hydroxy alkyl (meth)acrylates, methacrylic acids, acrylic acids, hydroxyethyl acrylates, and the like, any derivative thereof, or any combination thereof.

Suitable lubricating agents for use in conjunction with the present invention may include, but not be limited to, ethoxylated fatty acids (e.g., the reaction product of ethylene oxide with pelargonic acid to form poly(ethylene glycol) (“PEG”) monopelargonate; the reaction product of ethylene oxide with coconut fatty acids to form PEG monolaurate), and the like, or any combination thereof. The lubricant agents may also be selected from nonwater-soluble materials such as synthetic hydrocarbon oils, alkyl esters (e.g., tridecyl stearate which is the reaction product of tridecyl alcohol and stearic acid), polyol esters (e.g., trimethylol propane tripelargonate and pentaerythritol tetrapelargonate), and the like, or any combination thereof.

Suitable emulsifiers for use in conjunction with the present invention may include, but not be limited to, sorbitan monolaurate, e.g., SPAN® 20 (available from Uniqema, Wilmington, Del.), or poly(ethylene oxide) sorbitan monolaurate, e.g., TWEEN® 20 (available from Uniqema, Wilmington, Del.).

Suitable vitamins for use in conjunction with the present invention may include, but not be limited to, vitamin B compounds (including B1 compounds, B2 compounds, B3 compounds such as niacinamide, niacinnicotinic acid, tocopheryl nicotinate, C₁-C₁₈ nicotinic acid esters, and nicotinyl alcohol; B5 compounds, such as panthenol or “pro-B5”, pantothenic acid, pantothenyl; B6 compounds, such as pyroxidine, pyridoxal, pyridoxamine; carnitine, thiamine, riboflavin); vitamin A compounds, and all natural and/or synthetic analogs of Vitamin A, including retinoids, retinol, retinyl acetate, retinyl palmitate, retinoic acid, retinaldehyde, retinyl propionate, carotenoids (pro-vitamin A), and other compounds which possess the biological activity of vitamin A; vitamin D compounds; vitamin K compounds; vitamin E compounds, or tocopherol, including tocopherol sorbate, tocopherol acetate, other esters of tocopherol and tocopheryl compounds; vitamin C compounds, including ascorbate, ascorbyl esters of fatty acids, and ascorbic acid derivatives, for example, ascorbyl phosphates such as magnesium ascorbyl phosphate and sodium ascorbyl phosphate, ascorbyl glucoside, and ascorbyl sorbate; and vitamin F compounds, such as saturated and/or unsaturated fatty acids; or any combination thereof.

Suitable antimicrobials for use in conjunction with the present invention may include, but not be limited to, anti-microbial metal ions, chlorhexidine, chlorhexidine salt, triclosan, polymoxin, tetracycline, amino glycoside (e.g., gentamicin), rifampicin, bacitracin, erythromycin, neomycin, chloramphenicol, miconazole, quinolone, penicillin, nonoxynol 9, fusidic acid, cephalosporin, mupirocin, metronidazolea secropin, protegrin, bacteriolcin, defensin, nitrofurazone, mafenide, acyclovir, vanocmycin, clindamycin, lincomycin, sulfonamide, norfloxacin, pefloxacin, nalidizic acid, oxalic acid, enoxacin acid, ciprofloxacin, polyhexamethylene biguanide (PHMB), PHMB derivatives (e.g., biodegradable biguanides like polyethylene hexamethylene biguanide (PEHMB)), clilorhexidine gluconate, chlorohexidine hydrochloride, ethylenediaminetetraacetic acid (EDTA), EDTA derivatives (e.g., disodium EDTA or tetrasodium EDTA), and the like, and any combination thereof.

Antistatic agents (antistats) for use in conjunction with the present invention may comprise any suitable anionic, cationic, amphoteric or nonionic antistatic agent. Anionic antistatic agents may generally include, but not be limited to, alkali sulfates, alkali phosphates, phosphate esters of alcohols, phosphate esters of ethoxylated alcohols, or any combination thereof. Examples may include, but not be limited to, alkali neutralized phosphate ester (e.g., TRYFAC® 5559 or TRYFRAC® 5576, available from Henkel Corporation, Mauldin, S.C.). Cationic antistatic agents may generally include, but not be limited to, quaternary ammonium salts and imidazolines, which possess a positive charge. Examples of nonionics include the poly(oxyalkylene) derivatives, e.g., ethoxylated fatty acids like EMEREST® 2650 (an ethoxylated fatty acid, available from Henkel Corporation, Mauldin, S.C.), ethoxylated fatty alcohols like TRYCOL® 5964 (an ethoxylated lauryl alcohol, available from Henkel Corporation, Mauldin, S.C.), ethoxylated fatty amines like TRYMEEN® 6606 (an ethoxylated tallow amine, available from Henkel Corporation, Mauldin, S.C.), alkanolamides like EMID® 6545 (an oleic diethanolamine, available from Henkel Corporation, Mauldin, S.C.), or any combination thereof. Anionic and cationic materials tend to be more effective antistats.

To facilitate a better understanding of the present invention, the following representative examples of preferred embodiments are given. In no way should the following examples be read to limit, or to define, the scope of the invention.

### EXAMPLES

### Example 1

A heated collector was placed in series with a melt blown polymer filament extruder. The heated collector was an air forming jet (AFJ), described above in relation to FIGS. 6-14 with an inlet size of 16 mm by 155 mm with a length of 405 mm. The air forming jet was placed at varying distances from the melt blown polymer filament extruder. The heated air from the melt blown polymer filament extruder heated all four walls of the air forming jet. Table 1 provides the distance of the air forming jet inlet from the melt blown polymer filament extruder and the temperature of various parts of the air forming jet. The polymer used in Example 1 was PP3155 (a polypropylene homopolymer, available from ExxonMobil).

TABLE 1

| | Sample | | | | | | |
|---|---|---|---|---|---|---|---|
| | 1 | 2 | 3 | 4 | 5 | 6 | 7 |
| Collection | 89 | 89 | 127 | 152 | 203 | 152 | 203 |
| Distance (mm) | | | | | | | |
| Vacuum Air | 7.0 | 5.0 | 5.0 | 5.0 | 5.0 | 0.0 | 0.0 |
| Pressure (psig) | | | | | | | |
| Knife Gate Air | 32.5 | 40.0 | 40.0 | 40.0 | 40.0 | 50.0 | 50.0 |
| Pressure (psig) | | | | | | | |
| AFJ Surface | 115 | 100 | 98 | 97 | 98 | 94 | 93 |
| Temperature (° F.) | | | | | | | |
| Sample Surface | 224 | 165 | 152 | 154 | 152 | 143 | 143 |
| Temperature (° F.) | | | | | | | |
| Knife Gate Air | 520 | 520 | 520 | 520 | 520 | 520 | 520 |
| Temperature (° F.) | | | | | | | |

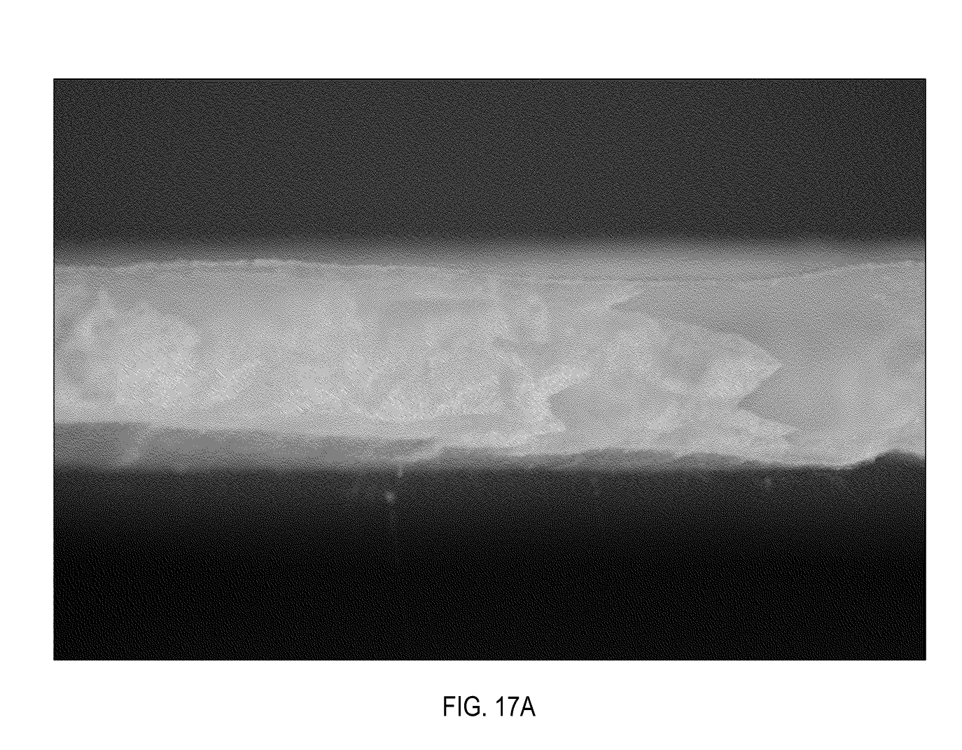

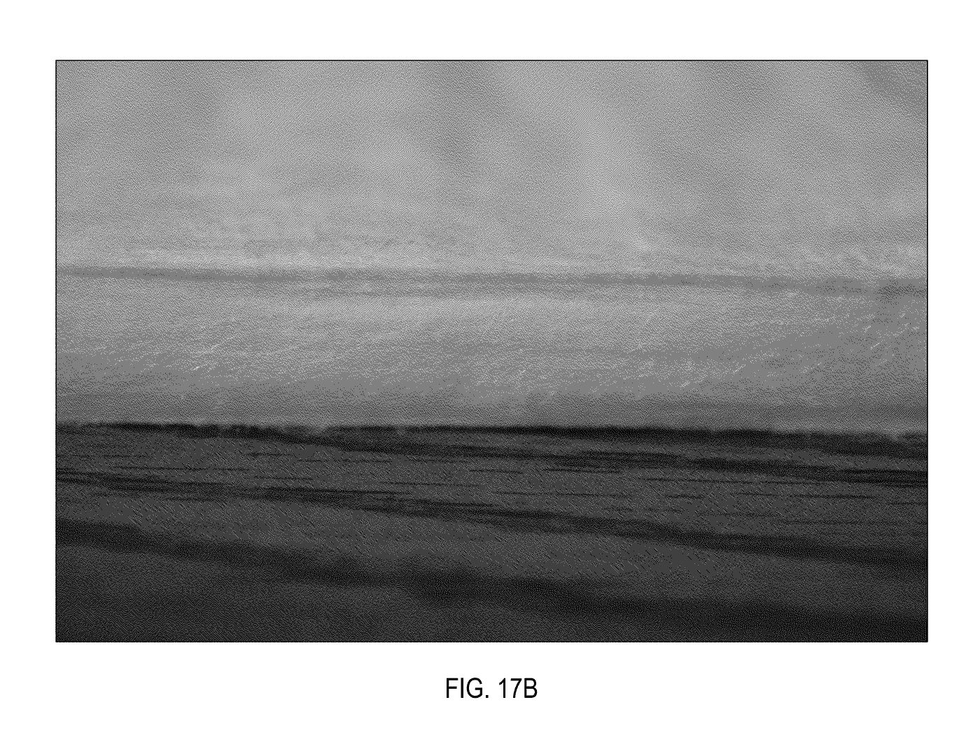

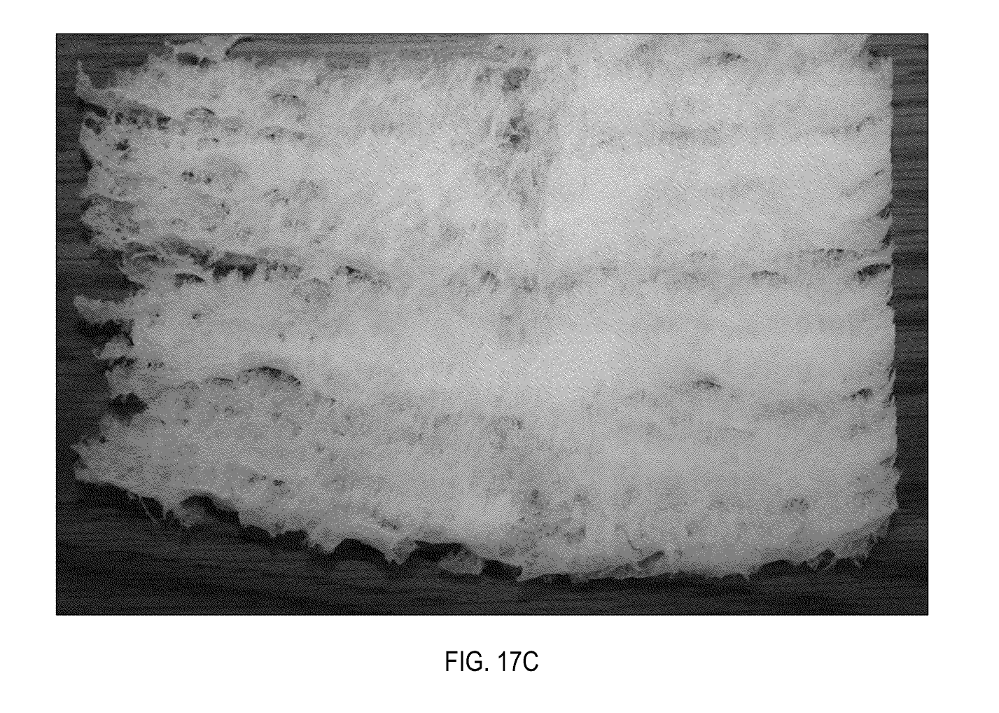

In order to initiate sample formation, a stop was inserted into the air forming jet to form a block structure that was then manually pulled through the outlet of the air forming jet to produce the in situ core/skin nonwoven materials. The rate at which the in situ core/skin nonwoven materials were pulled affected the stability and the basis weight of the samples. As all four walls of the air forming jet were heated, the in situ core/skin nonwoven materials produced had a core with a skin on the top, bottom, and both sides, the general structure of which is illustrated in FIG. 2A. FIGS. 17A-C provide photographs of a produced in situ core/skin nonwoven material (or component thereof). Specifically, FIG. 17A provides an end-on view showing the corrugated core with top and bottom skins of the produced in situ core/skin nonwoven material. FIG. 17B provides an angled side-view showing the top and side skins of the produced in situ core/skin nonwoven material. FIG. 17C provides a top view of the core of the produced in situ core/skin nonwoven material with the top, bottom, and side skins removed so that the corrugated structure of the core is more visible.

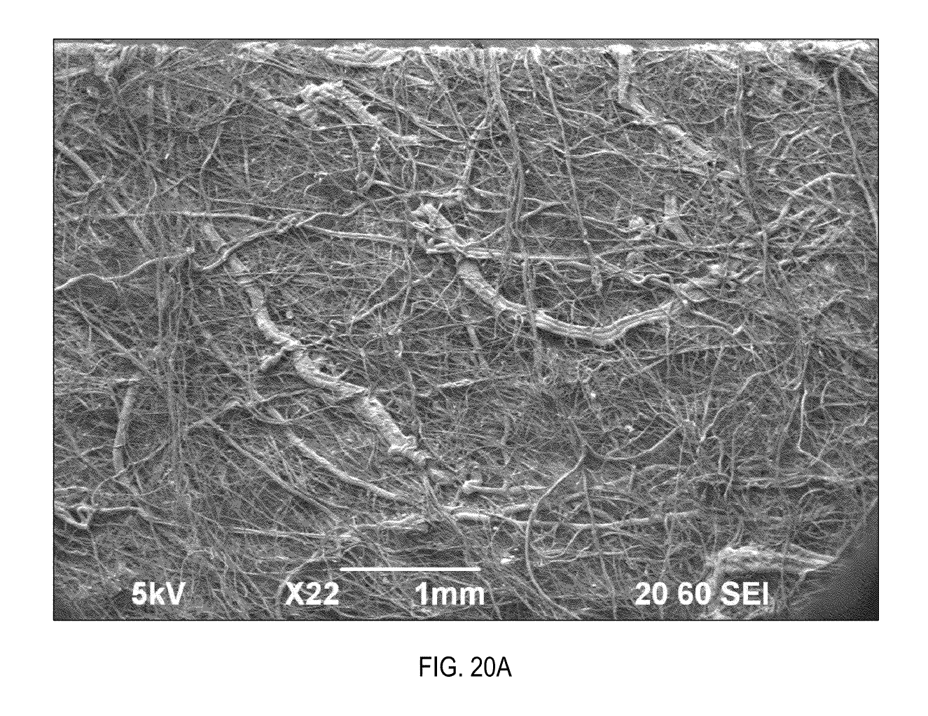

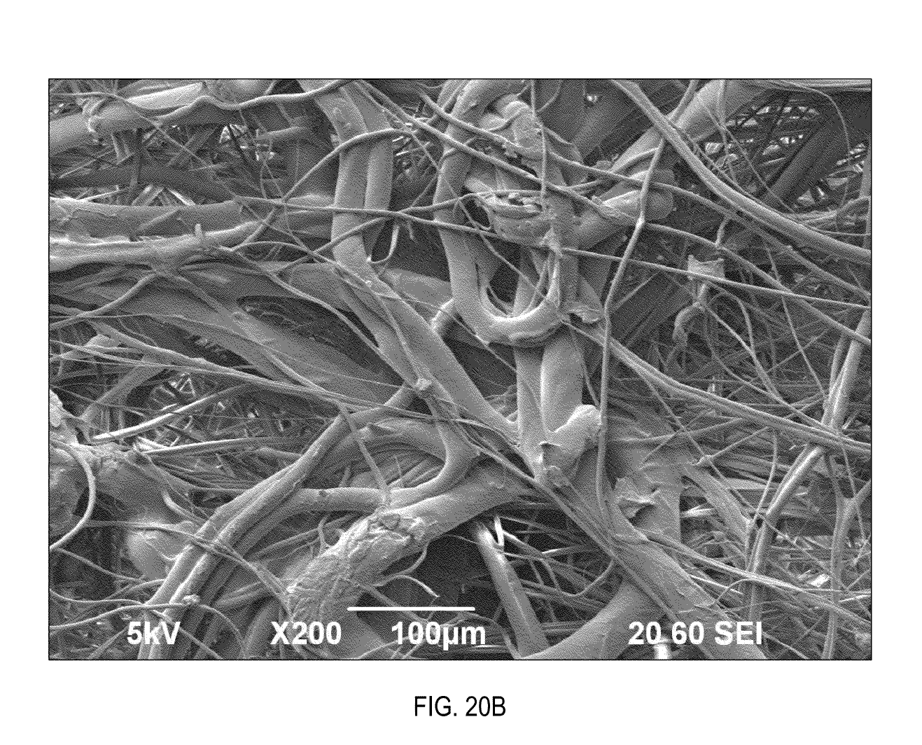

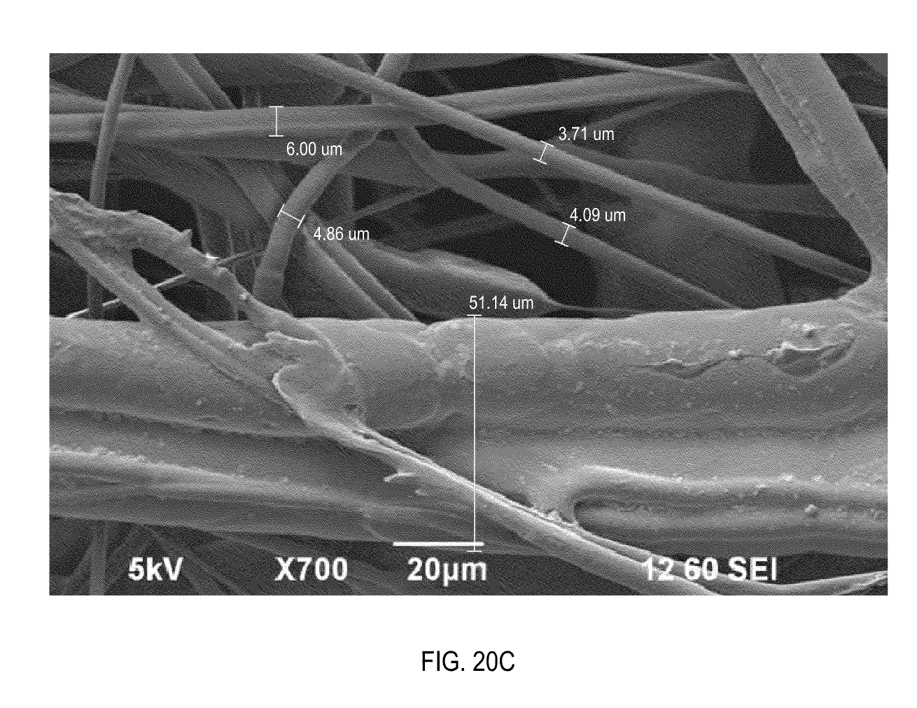

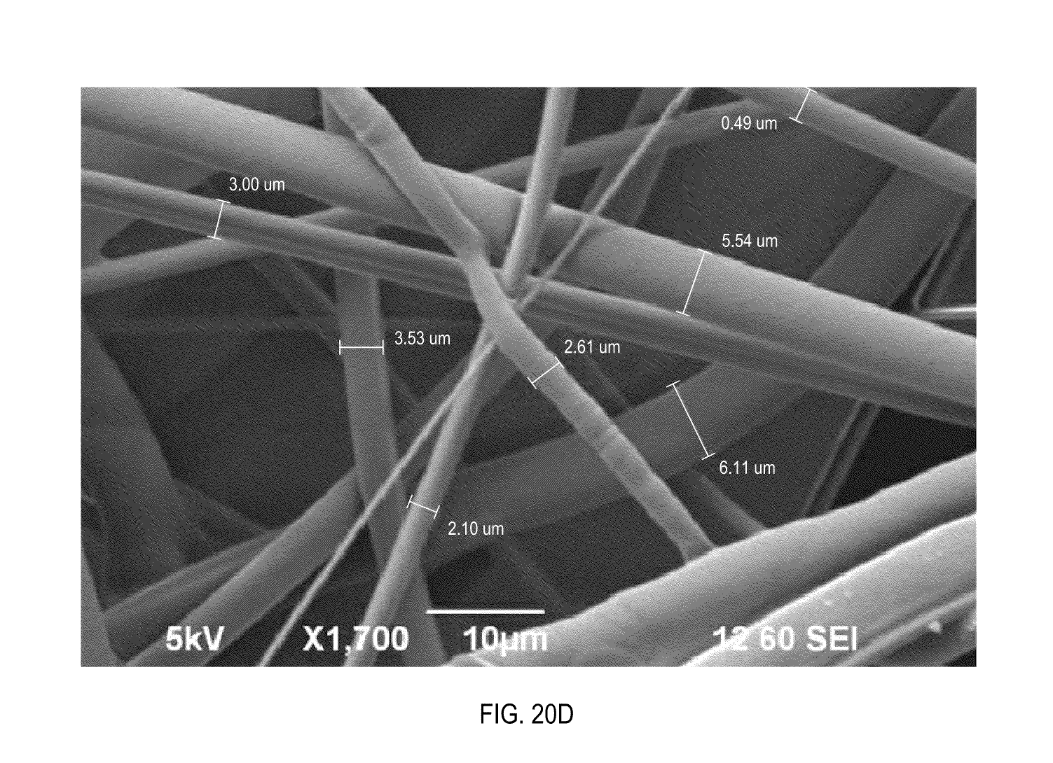

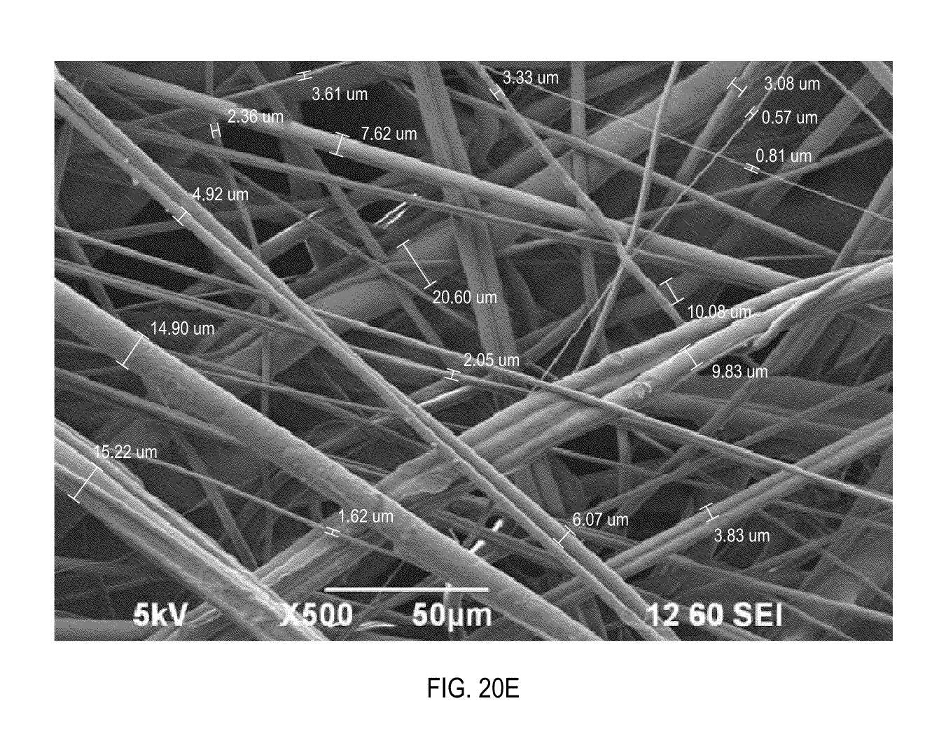

Further, the various components of the in situ core/skin nonwoven materials were imaged via scanning electron microscopy, some of the micrographs of which are provided in FIGS. 18-19. FIGS. 18A-B provide scanning electron micrographs of the core and top skin at different magnifications with FIG. 18B showing the skin thickness in one location to be about 380 microns. Further, FIG. 18A illustrates a corrugated density distribution within the core. FIGS. 19A-C provide scanning electron micrographs of the core at different magnifications with FIG. 19C showing the diameter of various polymer melt filaments in the core ranging from about 0.4 microns to about 3.5 microns. FIGS. 20A-E provide scanning electron micrographs of the skin in a top down view at different magnifications with FIGS. 20C-E showing the diameter of various polymer melt filaments in the skin ranging from about 0.5 microns to about 51 microns. These scanning electron micrographs illustrate the different diameter distributions, coalescence, and entanglement of the polymer melt filaments in the various components of the in situ core/skin nonwoven materials according to at least one embodiment of the present invention.

The various samples above were cut into three samples each and analyzed for basis weight and density with the results provided in Table 2.

TABLE 2

| | | | | | Basis | |
|---|---|---|---|---|---|---|
| | Width | Length | Height | Weight | Weight | Density |
| Sample | (cm) | (cm) | (cm) | (g) | (gsm) | (g/cm³) |
| 1A | 15 | 15.1 | 1.5 | 11.1 | 490 | 0.033 |
| 1B | 15.2 | 15 | 1.5 | 11.7 | 513 | 0.034 |
| 1C | 15.2 | 15 | 1.5 | 11.6 | 509 | 0.034 |
| 2A | 15.3 | 15 | 1.5 | 11.9 | 519 | 0.035 |
| 2B | 15.2 | 15 | 1.5 | 11.3 | 496 | 0.033 |
| 2C | 15.2 | 15.1 | 1.5 | 12.7 | 553 | 0.037 |
| 3A | 15 | 15.2 | 1.5 | 14 | 614 | 0.041 |
| 3B | 15 | 15.3 | 1.5 | 16.4 | 715 | 0.048 |
| 3C | 15 | 15.3 | 1.5 | 13.2 | 575 | 0.038 |
| 4A | 15.1 | 14.9 | 1.5 | 16.8 | 747 | 0.050 |
| 4B | 15.3 | 15.1 | 1.5 | 16.6 | 719 | 0.048 |
| 4C | 15.3 | 15.1 | 1.5 | 13.4 | 580 | 0.039 |
| 5A | 15.2 | 15.1 | 1.5 | 8.5 | 370 | 0.025 |
| 5B | 15.2 | 15.1 | 1.5 | 9.7 | 423 | 0.028 |
| 5C | 15.4 | 15.1 | 1.5 | 9.6 | 413 | 0.028 |
| 6A | 15.1 | 15 | 1.5 | 13 | 574 | 0.038 |
| 6B | 15.2 | 15 | 1.5 | 14 | 614 | 0.041 |
| 6C | 15.1 | 15 | 1.5 | 16.3 | 720 | 0.048 |
| 7A | 15 | 15 | 1.5 | 9.1 | 404 | 0.027 |
| 7B | 15 | 15 | 1.5 | 7.4 | 329 | 0.022 |
| 7C | 15.1 | 15 | 1.5 | 6.8 | 300 | 0.020 |

To test the oil absorbency of the samples and components thereof, one of the sample pieces was further cut into three smaller pieces. To the three pieces, one was left intact, one had the top skin removed, and the final sample had the top and bottom skin removed, no samples had side skins.

Oil absorbency was measured by placing an in situ core/skin nonwoven material sample in 10w30 Pennzoil motor oil. Once the sample sinks and stays submerged for one minute, the sample is removed from the motor oil and allowed to drain for two minutes. The weight of the sample after draining is divided by the weight of the sample before testing to provide an oil absorbency measure with the units g/g. Table 3 provides the oil absorbency for each sample tested.

TABLE 3

| | Dry | Sink | | | Oil |
|---|---|---|---|---|---|
| | Weight | Time | Wet Weight | Net Weight | Absorbency |
| Sample | (g) | (sec) | (g) | (g) | (g/g) |
| 1 intact | 2.49 | 108 | 34.41 | 31.92 | 12.8 |
| 1 one skin | 1.45 | 7 | 8.16 | 6.71 | 4.6 |
| 1 core | 2.5 | 12 | 22.6 | 20.1 | 8.0 |
| 3 intact | 6.87 | 360 | 104.55 | 97.68 | 14.2 |
| 3 one skin | 4.62 | 15 | 51.95 | 47.33 | 10.2 |
| 3 core | 2.71 | 16 | 25.46 | 22.75 | 8.4 |
| 4 intact | 7.7 | 911 | 121.88 | 114.18 | 14.8 |
| 4 one skin | 7.24 | 25 | 113.95 | 106.71 | 14.7 |
| 4 core | 3.74 | 17 | 52.28 | 48.54 | 13.0 |
| 5 intact | 2.61 | 384 | 89.29 | 86.68 | 33.2 |
| 5 one skin | 2.23 | 12 | 55.45 | 53.22 | 23.9 |
| 5 core | 2.01 | 10 | 38.17 | 36.16 | 18.0 |
| 6 intact | 7.24 | 132 | 52.94 | 45.7 | 6.3 |
| 6 one skin | 5.95 | 13 | 31.17 | 25.22 | 4.2 |
| 6 core | 3.02 | 13 | 21.9 | 18.88 | 6.3 |
| 7 intact | 3.65 | 236 | 118.75 | 115.1 | 31.5 |
| 7 one skin | 2.66 | 12 | 57.02 | 54.36 | 20.4 |
| 7 core | 1.52 | 10 | 26.14 | 24.62 | 16.2 |

*Sample two was not measured due to integrity issues.

The oil absorbency results indicate the synergistic effect of an in situ core/skin nonwoven material having a skin on all sides (as illustrated in FIG. 2A) and a lower density core. This may be due to the skin on all sides providing not only absorbency but also retention of the fluid absorbed into the core.

Air permeability of the samples intact was measured using ASTM D737 with a FRAZIER® Differential Pressure Air Permeability Measuring Instrument (available from Frazier Instruments).

TABLE 4

| Sample | Air Permeability (cfm/f²) |
|---|---|
| 1 | 21 |
| 2 | 21 |
| 3 | 9 |
| 4 | 10 |
| 5 | 40 |
| 6 | 33 |
| 7 | 40 |

Generally, the air permeability appears to track with density, such that decreasing density yields higher air permeability.

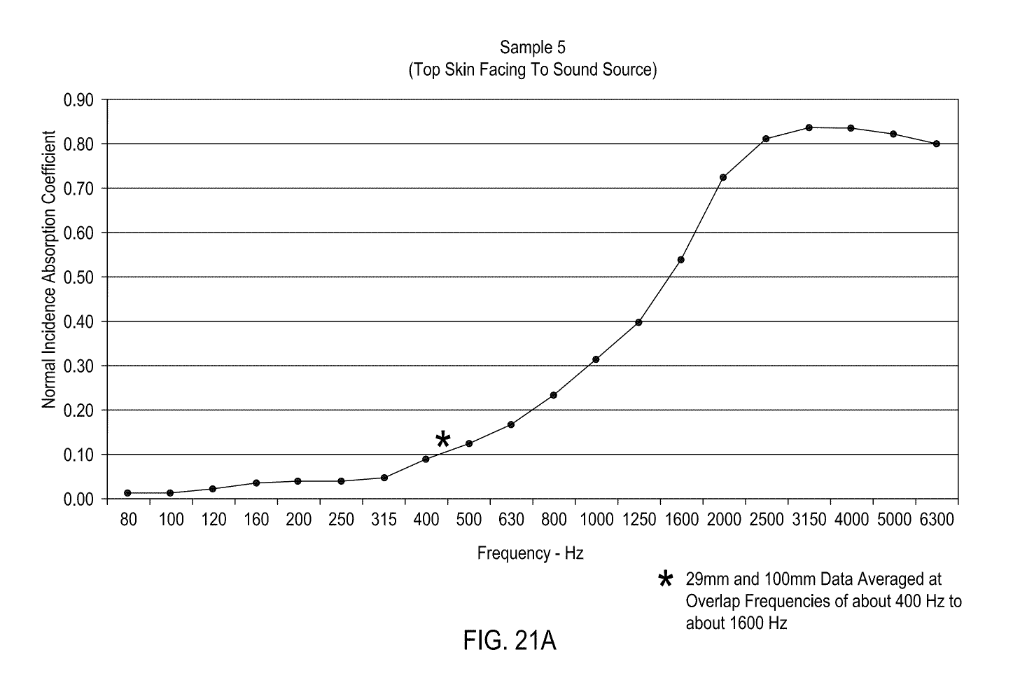

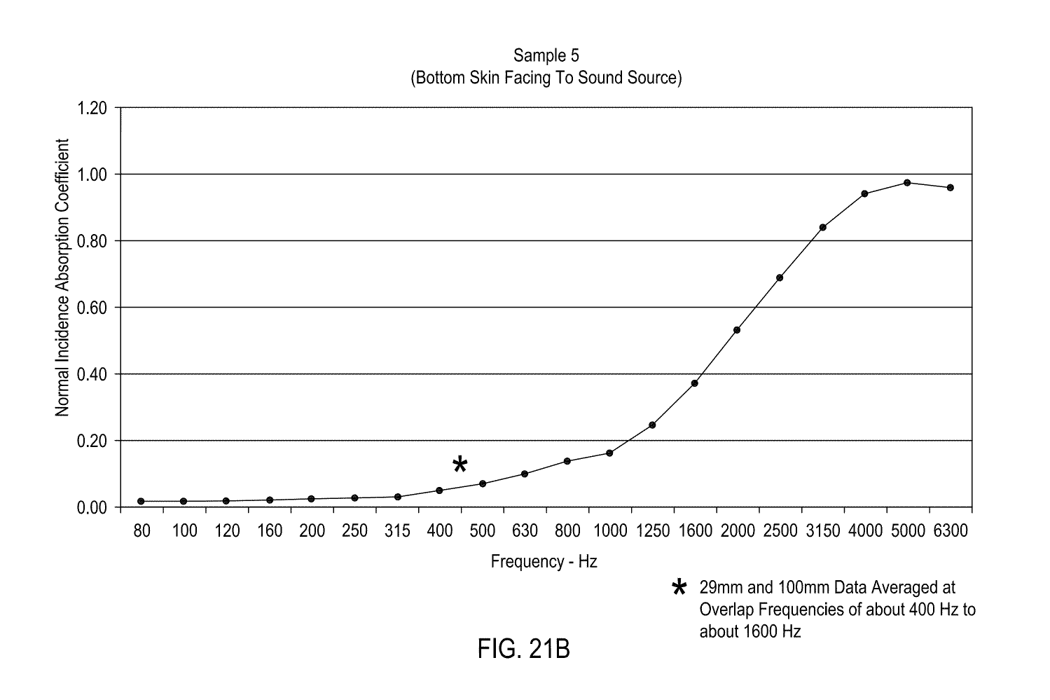

A portion of sample 5 was further tested for thermal conductivity according to ASTM C518 (results in Table 5), air flow resistance according to C522-002 (2009) (results in Table 6), and normal incidence sound absorption according to ASTM E1050-10 (results in Tables 7A-B and FIGS. 21A-B for the top skin facing the sound source and the bottom skin facing the sound source, respectively).

TABLE 5

| | Test | | | | |
|---|---|---|---|---|---|
| Test | Temp. | Test | Test | K-Value | R-Value |
| Thickness | Hot | Temp. | Temp. | (Btu-in/hr | (hr ft² |
| Inches | (° F.) | Cold (° F.) | Mean (° F.) | ft³ ° F.) | ° F./Btu) |
| 0.57 | 95.0 | 55.0 | 75.0 | 0.345 | 1.67 |

TABLE 6

| | | | | Specific Air | |
|---|---|---|---|---|---|
| | | | Basis | Flow | Air Flow |
| | Weight | Thickness | Weight | Resistance | Resistivity |
| Sample | (g) | (mm) | (kg/m²) | (mks Rayls) | (mks Rayles/m) |
| as | 2.99 | 14.42 | 0.39 | 733.98 | 50,897.27 |
| received | | | | | |
| bottom | 0.87 | 0.64 | 0.11 | 250.94 | 391,263.32 |
| skin | | | | | |
| top skin | 1.25 | 0.87 | 0.16 | 527.52 | 606,384.14 |
| core with | 1.45 | 13.41 | 0.18 | 3.15 | 235.15 |
| skins | | | | | |
| removed | | | | | |

TABLE 7A

| | Normal Incidence Absorption Coefficient | | |
|---|---|---|---|
| | | | Average at |
| Frequency | | | Overlap |
| (Hz) | 29 mm Data | 100 mm Data | Frequencies |
| 80 | ******** | 0.01 | 0.01 |
| 100 | ******** | 0.01 | 0.01 |
| 125 | ******** | 0.02 | 0.02 |
| 160 | ******** | 0.03 | 0.03 |
| 200 | ******** | 0.04 | 0.04 |
| 250 | ******** | 0.04 | 0.04 |
| 315 | ******** | 0.05 | 0.05 |
| 400 | 0.12 | 0.06 | 0.09 |
| 500 | 0.17 | 0.08 | 0.12 |
| 630 | 0.23 | 0.11 | 0.17 |
| 800 | 0.29 | 0.18 | 0.23 |
| 1000 | 0.34 | 0.28 | 0.31 |
| 1250 | 0.38 | 0.41 | 0.40 |
| 1600 | 0.53 | 0.55 | 0.54 |
| 2000 | 0.72 | ******** | 0.72 |
| 2500 | 0.81 | ******** | 0.81 |
| 3150 | 0.84 | ******** | 0.84 |
| 4000 | 0.83 | ******** | 0.83 |
| 5000 | 0.82 | ******** | 0.82 |
| 6300 | 0.80 | ******** | 0.80 |

TABLE 7B

| | Normal Incidence Absorption Coefficient | | |
|---|---|---|---|
| | | | Average at |
| Frequency | | | Overlap |
| (Hz) | 29 mm Data | 100 mm Data | Frequencies |
| 80 | ******** | 0.01 | 0.01 |
| 100 | ******** | 0.01 | 0.01 |
| 125 | ******** | 0.02 | 0.02 |
| 160 | ******** | 0.03 | 0.03 |
| 200 | ******** | 0.03 | 0.03 |
| 250 | ******** | 0.04 | 0.04 |
| 315 | ******** | 0.04 | 0.04 |
| 400 | 0.06 | 0.05 | 0.05 |
| 500 | 0.08 | 0.06 | 0.07 |
| 630 | 0.12 | 0.08 | 0.10 |
| 800 | 0.15 | 0.12 | 0.14 |
| 1000 | 0.16 | 0.17 | 0.17 |
| 1250 | 0.26 | 0.24 | 0.25 |
| 1600 | 0.40 | 0.34 | 0.37 |
| 2000 | 0.54 | ******** | 0.54 |
| 2500 | 0.69 | ******** | 0.69 |
| 3150 | 0.85 | ******** | 0.85 |
| 4000 | 0.95 | ******** | 0.95 |
| 5000 | 0.98 | ******** | 0.98 |
| 6300 | 0.97 | ******** | 0.97 |

Utilizing the data in Table 6, a noise reduction coefficient (“NRC”) was calculated for the in situ core/skin nonwoven material with the top skin facing the sound source and with the bottom skin facing the sound source, respectively. Further, similar data was collected for other commercially available materials utilizing the same procedures at the same thickness of 0.5 inches. The calculated noise reduction coefficient for each are provided in Table 8.

TABLE 8

| Material | Calculated NRC |
|---|---|
| sample 5 with the top skin facing the | 0.42 |
| sound source | |
| sample 5 with the bottom skin facing the | 0.28 |
| sound source | |
| 120 g/ft² K10 polyester | 0.26 |
| (a nonwoven material of polyester | |
| fibers, available from 3M) | |
| 3PCF fiberglass | 0.24 |
| (a nonwoven fiberglass material, | |
| available from OwensCorning) | |
| polyurethane foam having a density of | 0.17 |
| 0.028 g/mL | |

Generally, sample 5 can be characterized as having average thermal insulation properties and excellent acoustic dampening properties. Those in combination with a rigid skin provide a unique set of characteristics for an in situ core/skin nonwoven material. Further, because the production method utilizes a single collector and does not involve secondary steps to attach the in situ core/skin nonwoven material to another layer, this example demonstrates the unique structures and advantageous systems and methods described herein.

### Example 2

A heated collector was placed in series with a melt blown polymer filament extruder. The heated collector was an air forming jet, described above in relation to FIGS. 6-14. The inlet and outlet sizes were changed for various samples, and the inlet width was 155 mm unless otherwise specified. Further, the air forming jet was placed at varying distances from the melt blown polymer filament extruder. The heated air from the melt blown polymer filament extruder heated all four walls of the air forming jet and a chiller set at −5° C. was used to regulate the temperature of the walls. It should be noted that while the chiller was set to −5° C., the water temperature around the walls may have been different based on heat absorbed by the heated collector. The polymer used in Example 2 was PP3155 (a polypropylene homopolymer, available from ExxonMobil).

Further, three control samples were prepared by standard nonwoven meltblown techniques by collecting the polymer melt filaments on a conveyor. Control 1 (“C1”) was formed from PP5135G (polypropylene random copolymer, available from Pinnacle). Control 2 (“C2”) was formed from PP3155 (a polypropylene homopolymer, available from ExxonMobil). Control 3 (“C3”) was formed from a polypropylene homopolymer.

Table 8 provides the conditions under which the various samples collected in the air forming jet. The return coolant temperature in Table 8 refers to the temperature of the coolant after having chilled the air forming jet. In each sample where a chiller was used, the bath temperature was set to maintain the coolant—5° C. “NC” denotes samples that were prepared without use of the chiller.

TABLE 8

| | | | Knife | | | |
|---|---|---|---|---|---|---|
| | | Vacuum | Gate | Coolant | | |
| | Collection | Air | Air | Return | Inlet | Outlet |
| | Distance | Pressure | Pressure | Temperature | Height | Height |
| Sample | (mm) | (psig) | (psig) | (° C.) | (mm) | (mm) |
| 8 | 254 | 5 | 10 | 10 | 29 | 60 |
| 9 | 254 | 5 | 10 | NC | 29 | 60 |
| 10 | 203 | 5 | 10 | 10 | 29 | 60 |
| 11* | 254 | 5 | 10 | NC | 29 | 60 |
| 12 | 254 | 5 | 10 | 11.6 | 40 | 43 |
| 13 | 254 | 5 | 10 | NC | 40 | 43 |
| 14 | 495 | 5 | 10 | NC | 19 | 43 |
| 15 | 635 | 5 | 10 | NC | 19 | 43 |
| 16 | 737 | 5 | 10 | NC | 19 | 43 |
| 17 | 813 | 5 | 10 | NC | 19 | 43 |
| 18 | 364 | 5 | 10 | NC | 19 | 43 |
| 19 | 965 | 5 | 10 | NC | 19 | 43 |

*Inlet Width = 250 mm

Using the same procedures in Example 1 above, the various properties of the in situ core/skin nonwoven materials were measured on three portions of each sample. Table 9 reports the average of the three sample portions.

TABLE 9

| | Height | Basis Weight | Density | Oil Abs. | Air Perm. |
|---|---|---|---|---|---|
| Sample | (cm) | (gsm) | (g/cm³) | (g/g) | (cfm/f²) |
| C1 | 0.4 | 419 | 0.105 | 8.3 | 14.2 |
| C2 | 0.8 | 299 | 0.037 | 14.9 | 38.4 |
| C3 | 1.2 | 802 | 0.067 | 12.5 | 10.8 |
| 8 | 2.7 | 400 | 0.015 | 12.0 | 76.6 |
| 9 | 2.7 | 399 | 0.015 | 12.7 | 68.8 |
| 10 | 2.7 | 430 | 0.016 | 15.9 | 74.8 |
| 11 | 2.7 | 468 | 0.017 | 8.3 | 73.5 |
| 12 | 3.6 | 529 | 0.015 | 7.2 | 176.3 |
| 13 | 3.6 | 629 | 0.017 | 6.2 | 162.0 |
| 14 | 1.4 | 298 | 0.021 | 15.4 | 136.3 |
| 15 | 1.2 | 225 | 0.019 | 21.0 | 157.7 |
| 16 | 1.0 | 242 | 0.024 | 19.0 | 155.2 |
| 17 | 0.8 | 237 | 0.030 | 14.4 | 133.4 |
| 18 | 0.6 | 304 | 0.051 | 13.8 | 123.6 |
| 19 | 0.4 | 214 | 0.054 | 15.2 | 168.0 |

Upon visual inspection sample 8 with a chilled air forming jet has a thinner skin as compared to sample 9. As samples 8 and 9 were formed at the same distance to the air forming jet, the basis weight and total density are comparable. However, the oil absorbency is higher and air permeability lower for the thicker skinned sample 9.

Upon visual inspection samples 12 and 13, where the inlet and outlet sizes were appreciably increased, were highly across the sample. Further, the structure of the samples were becoming more similar to that of a control in situ core/skin nonwoven material, i.e., having a thinner skin. However, samples 12 and 13 advantageously have a higher caliper than the control samples, in some instances by about 9 times.

Samples 14-19 were prepared under the same conditions with increasing distances between the die and the inlet of the air forming jet. As the distance from the die increased, the caliper decreased and the in situ core/skin nonwoven material looked more like a traditional nonwoven material. However, the density of the in situ core/skin nonwoven material from the air forming jet remained low relative to the caliper, and the in situ core/skin nonwoven material had a very soft feel as compared to the control nonwoven materials.

Samples 8, 9, 11, and 13 were tested for thermal conductivity via ASTM C518 methods with the hot test temperature of 95.03° F., the cold test temperature of 55.03° F., and the mean test temperature of 75.03° F. The results shown in Table 10 demonstrate reasonable thermal insulation properties for the thickness of the sample.

TABLE 10

| | Test Thickness | K-Value | R-Value |
|---|---|---|---|
| Sample | Inches | (Btu-in/hr ft³ ° F.) | (hr ft² ° F./Btu) |
| 8 | 1.05 | 0.4605 | 2.28 |
| 9 | 1.05 | 0.4697 | 2.24 |
| 11 | 1.01 | 0.3674 | 2.75 |
| 13 | 1.32 | 0.5305 | 2.49 |

Sample 11 was tested for air flow resistance via ASTM C522. The results shown in Table 11 show a sample that is less resistant to air flow as compared to the sample tested in Example 1, which may be due, at least in part, to the higher caliper, lower density, and thinner skin characteristics of sample 11.

TABLE 11

| | | | | Specific Air | |
|---|---|---|---|---|---|
| | | | Basis | Flow | Air Flow |
| | Weight | Thickness | Weight | Resistance | Resistivity |
| Sample | (g) | (mm) | (kg/m²) | (mks Rayls) | (mks Rayles/m) |
| as | 5.27 | 24.45 | 0.69 | 132.76 | 5430.28 |
| received | | | | | |
| bottom | 0.68 | 0.63 | 0.9 | 47.88 | 75,402.96 |
| skin | | | | | |
| top skin | 0.89 | 0.89 | 0.12 | 69.32 | 77,979.54 |
| core with | 3.83 | 20.45 | 0.49 | 15.38 | 752.11 |
| skins | | | | | |
| removed | | | | | |

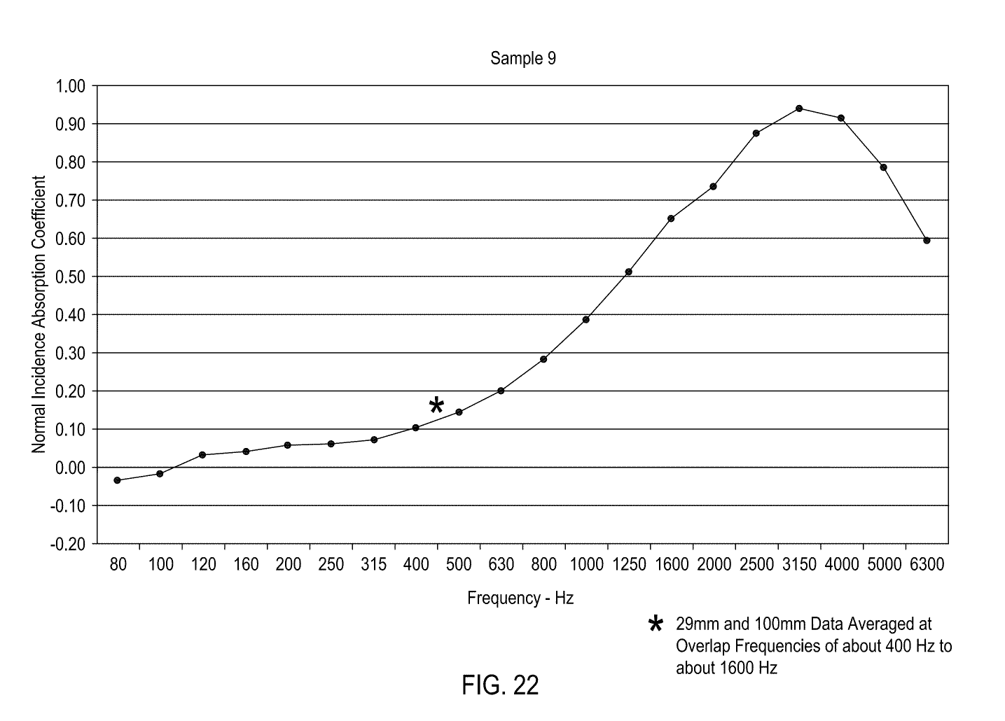

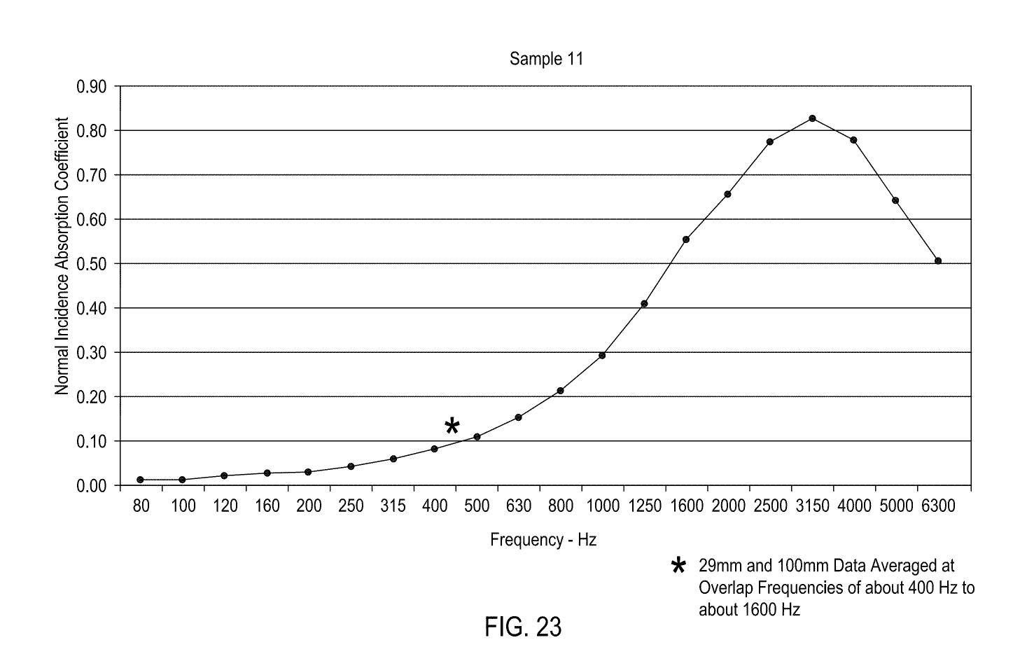

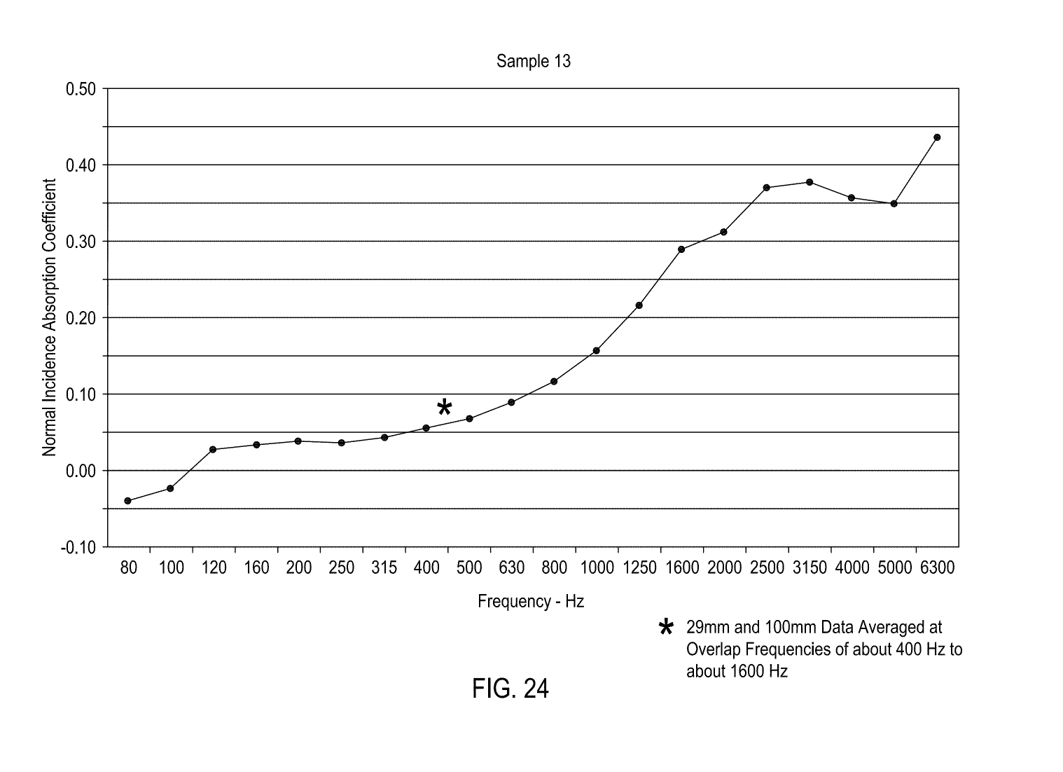

Samples 9, 11, and 13 were tested for normal incidence sound absorption via ASTM E-1050, the results of which are presented in FIGS. 22-24, respectively. Samples 9 and 11 demonstrate excellent acoustic dampening properties, while sample 13 is poor. These differences may be due to, at least in part, primarily the higher caliper and to some extent the higher basis weight of sample 13.

Utilizing the data in Table 11, a noise reduction coefficient (“NRC”) was calculated for sample 11. Further, similar data was collected for other commercially available materials utilizing the same procedures at the same thickness of 24.45 mm (about 1 inch). The calculated noise reduction coefficient for each are provided in Table 12.

TABLE 12

| Material | Calculated NRC |
|---|---|
| Sample 11 | 0.4 |
| 120 g/ft² K10 polyester | 0.47 |
| 3PCF fiberglass | 0.57 |
| polyurethane foam having a density of | 0.24 |
| 0.028 g/mL | |

This example demonstrates the versatility, in at least some embodiments, of the heated collectors and systems of the present invention for producing in situ core/skin nonwoven materials with desired characteristics. This example also further demonstrates the ability to produce in situ core/skin nonwoven materials with unique structures that can be characterized as having average thermal insulation properties and higher acoustic dampening properties. Further, because the production method utilizes a single collector and does not involve secondary steps to attach the in situ core/skin nonwoven material to another layer, this example demonstrates the unique structures and advantageous systems and methods described herein.

### Example 3

A heated collector was placed in series with a melt blown polymer filament extruder. The heated collector was an air forming jet (AFJ), described above in relation to FIGS. 6-14 with an inlet size of 29 mm by 155 mm with a length of 405 mm. The air forming jet was placed at varying distances from the melt blown polymer filament extruder. The heated air from the melt blown polymer filament extruder heated all four walls of the air forming jet. The polymer used in Example 3 was PP3546G Homopolymer Grade for Ultra-High Melt Flow Rate Nonwoven Applications (available from ExxonMobil). It should be noted that the heated collector (i.e., air forming jet) was not cooled during the production of samples 20-22.

Table 13 provides the conditions under which the various samples were collected in the air forming jet. Interestingly, production of these in situ core/skin nonwoven materials required less initial guiding through the air forming jet as compared to Examples 1-2. That is, the Venturi flow provided the necessary force to move these samples thought the air forming jet.

TABLE 13

| | | Vacuum | Knife Gate | | |
|---|---|---|---|---|---|
| | Collection | Air | Air | Inlet | Outlet |
| | Distance | Pressure | Pressure | Height | Height |
| Sample | (mm) | (psig) | (psig) | (mm) | (mm) |
| 20 | 254 | 5 | 7 | 29 | 60 |
| 21 | 254 | 20 | 7 | 29 | 60 |
| 22 | 254 | 20 | 9 | 29 | 60 |

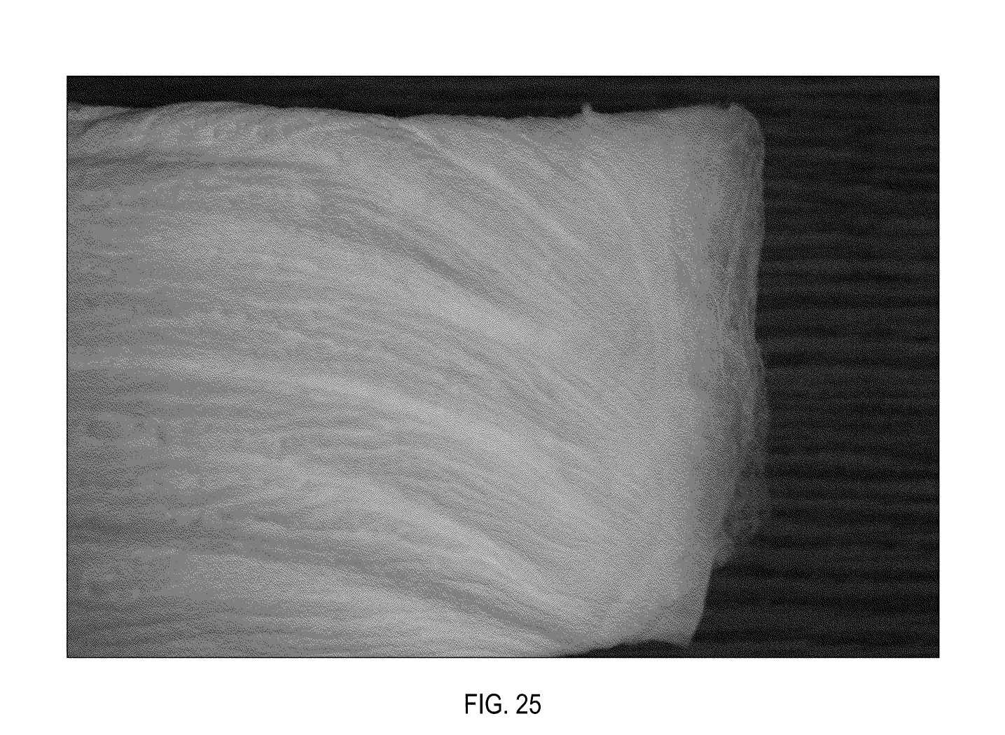

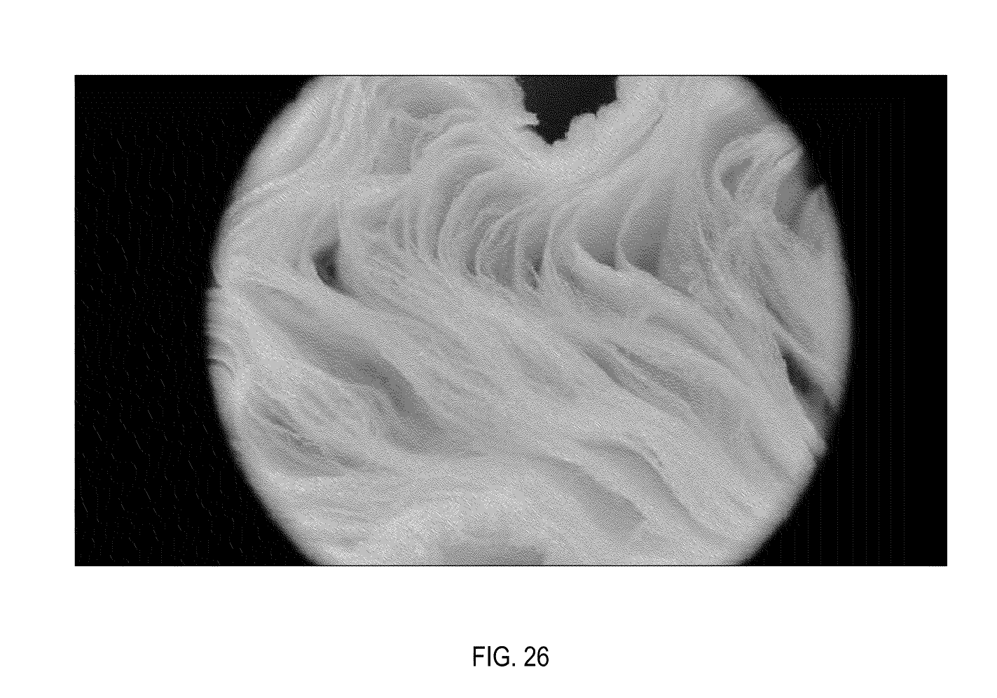

Upon visual inspection, the in situ core/skin nonwoven materials produced in Example 3 where very different than those produced in the previous two examples. As shown in FIG. 25, a top view of the as produced in situ core/skin nonwoven material, the structure of the in situ core/skin nonwoven material is ribbed with less defined edges as compared to the in situ core/skin nonwoven materials produced in the previous two examples. Upon close inspection, the core of the in situ core/skin nonwoven material has a “fish gill” structure shown in FIG. 26 as opposed to the corrugated structure from the previous two examples. Further, the skin of these in situ core/skin nonwoven materials is more integral to the core and has a phyllo-structure. That is, when the thicker outer layer, i.e., skin, is peeled away from the core in layers and after a few layers are peeled back, portions of the core peel away with the skin. It is believed that the structural differences are due, at least in part, to the different polymer compositions and the fact that the Venturi flow appeared to interact more with the sample during formation as compared to the previous two examples. The first two examples used a low melt flow index polymer, while this example used a high melt flow index polymer.

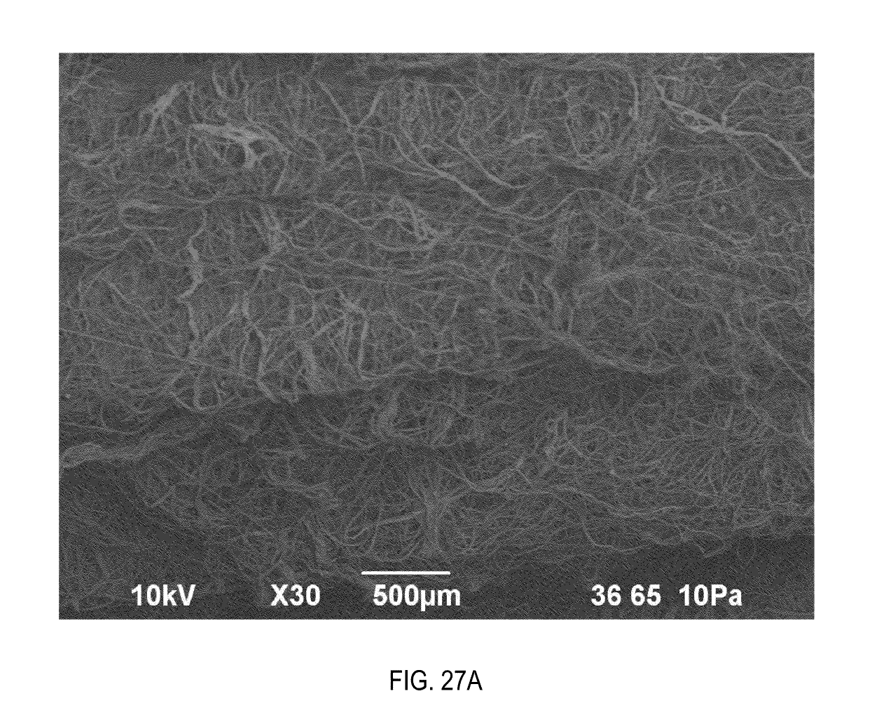

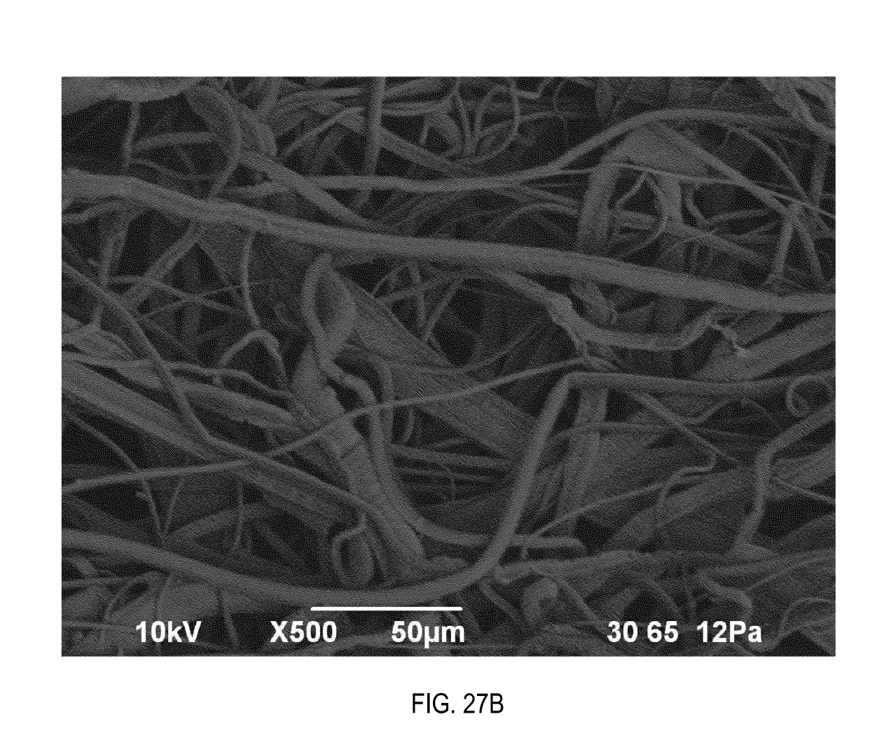

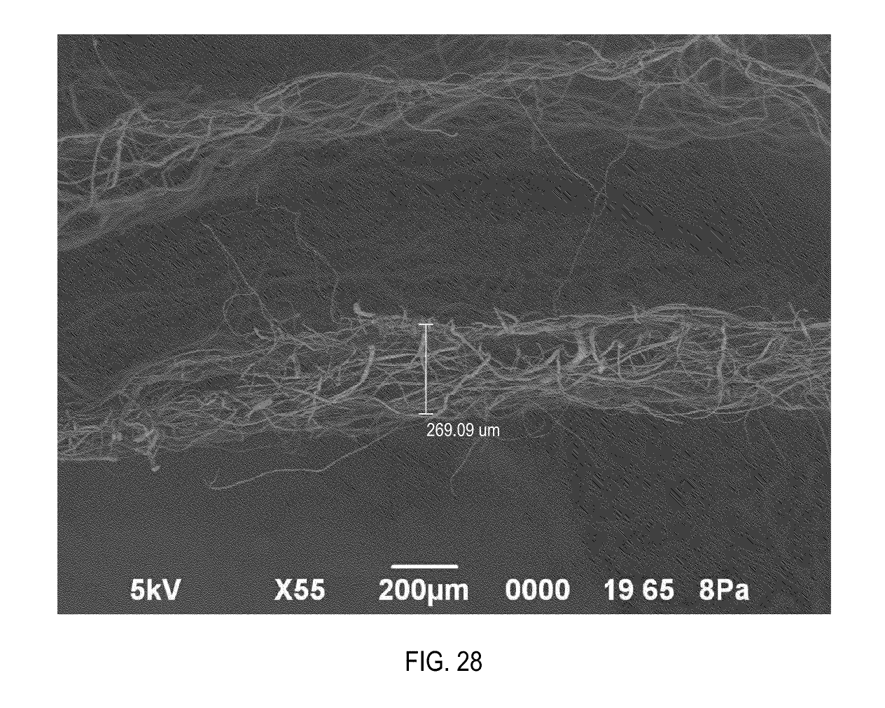

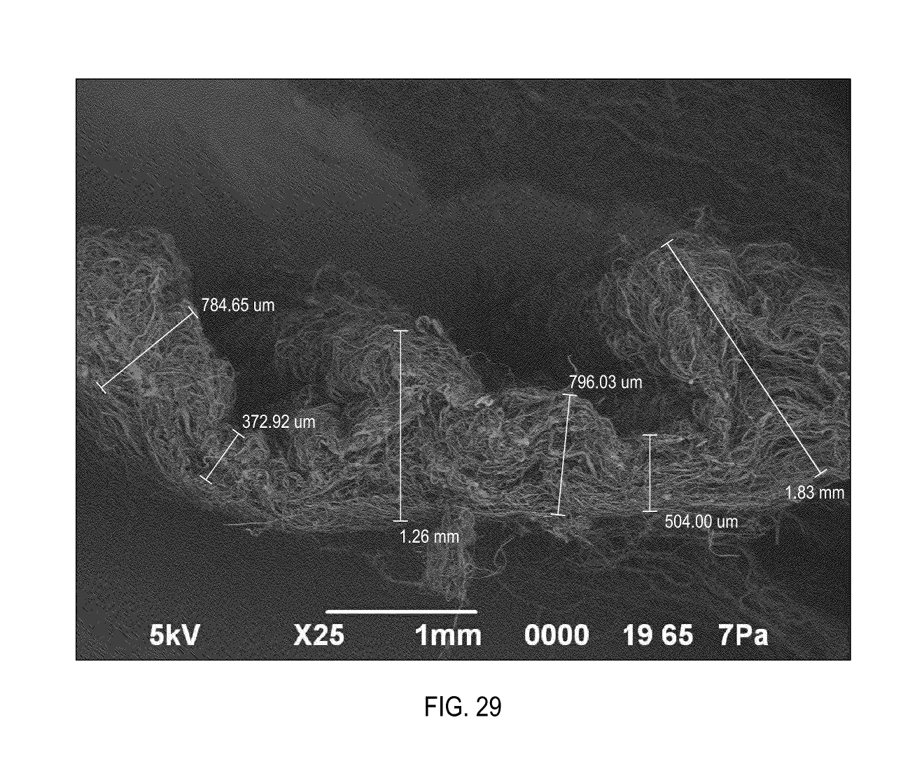

Scanning electron micrographs were taken of the skin surface, core, and skin/core interface for sample 21 and are shown in FIGS. 27A-B, FIG. 28, and FIG. 29, respectively. Specifically, FIGS. 27A-B provide micrographs of the skin in a top-down view at several magnifications that show the polymer melt filament are greatly entangled and some have coalesced as was the case in the previous two examples. FIG. 28 provides a micrograph of the inner “gill-like” structures in a side view. The gills measure about 200-300 microns in width and have about 400-600 microns between the gills in some locations. These large void spaces may provide advantageous thermal and acoustic properties. FIG. 29 provides a micrograph of the skin in a side view that illustrates the layered or phyllo-nature of the skin. Further, in the bottom right corner, the micrograph illustrates a gill of the core approaching and integrating with the proximal (most interior) layer of the skin.

Using the same procedures in Example 1 above, various properties of the in situ core/skin nonwoven materials were measured on three portions of each sample. Table 14 reports the average of the three sample portions. Control sample “C4” was prepared by standard nonwoven meltblown techniques by collecting the polymer melt filaments on a conveyor. Control 4 (“C4”) was formed from PP3546G (a polypropylene homopolymer, available from ExxonMobil).

TABLE 14

| | Height | Basis Weight | Density | Oil Abs. | Air Perm. |
|---|---|---|---|---|---|
| Sample | (cm) | (gsm) | (g/cm³) | (g/g) | (cfm/f²) |
| C4 | 2.6 | 410 | 0.0158 | 37.5 | 6.15 |
| 20 | 2.3 | 295 | 0.0128 | 36.6 | 14.13 |
| 21 | 2.0 | 251 | 0.0126 | 38.9 | 21.60 |
| 22 | 1.9 | 136 | 0.0072 | 52.4 | 40.20 |

The samples in this example appear to have the highest oil absorbency, which may be due to, at least in part, the void space and gill structure being able to trap and hold the oil.

Samples 21 and 22 were tested for thermal conductivity via ASTM C518 methods with the hot test temperature of 95.03° F., the cold test temperature of 55.03° F., and the mean test temperature of 75.03° F. The results shown in Table 15 demonstrate excellent thermal insulation properties for the thickness of the sample, ˜3.5 R-value/in. For example, a commonly used thermal insulation material THINSULATE® (a lofted synthetic fiber material, available from 3M Corporation) has a reported thermal insulation value of about 4.0 R-value/in, which is claimed to be 1 to 2 times the insulation of duck down.

TABLE 15

| | Test Thickness | K-Value | R-Value |
|---|---|---|---|
| Sample | Inches | (Btu-in/hr ft³ ° F.) | (hr ft² ° F./Btu) |
| 21 | 0.80 | 0.2748 | 2.91 |
| 22 | 0.80 | 0.299 | 2.68 |

Sample 22 was tested for air flow resistance via ASTM C522. The results shown in Table 16 show a sample that is less resistant to air flow as compared to the sample tested in Example 1, which may be due, at least in part, to the higher caliper and lower density characteristics of sample 22.

TABLE 16

| | | | | Specific Air | |
|---|---|---|---|---|---|
| | | | Basis | Flow | Air Flow |
| | Weight | Thickness | Weight | Resistance | Resistivity |
| Sample | (g) | (mm) | (kg/m²) | (mks Rayls) | (mks Rayles/m) |
| as | 1.26 | 16.56 | 0.16 | 440.47 | 26,596.87 |
| received | | | | | |
| bottom | 0.42 | 0.46 | 0.05 | 65.31 | 142,848.53 |
| skin | | | | | |
| top skin | 0.49 | 0.56 | 0.06 | 99.83 | 178,647.98 |
| core with | 0.34 | 11.43 | 0.04 | 36.13 | 3160.75 |
| skins | | | | | |
| removed | | | | | |

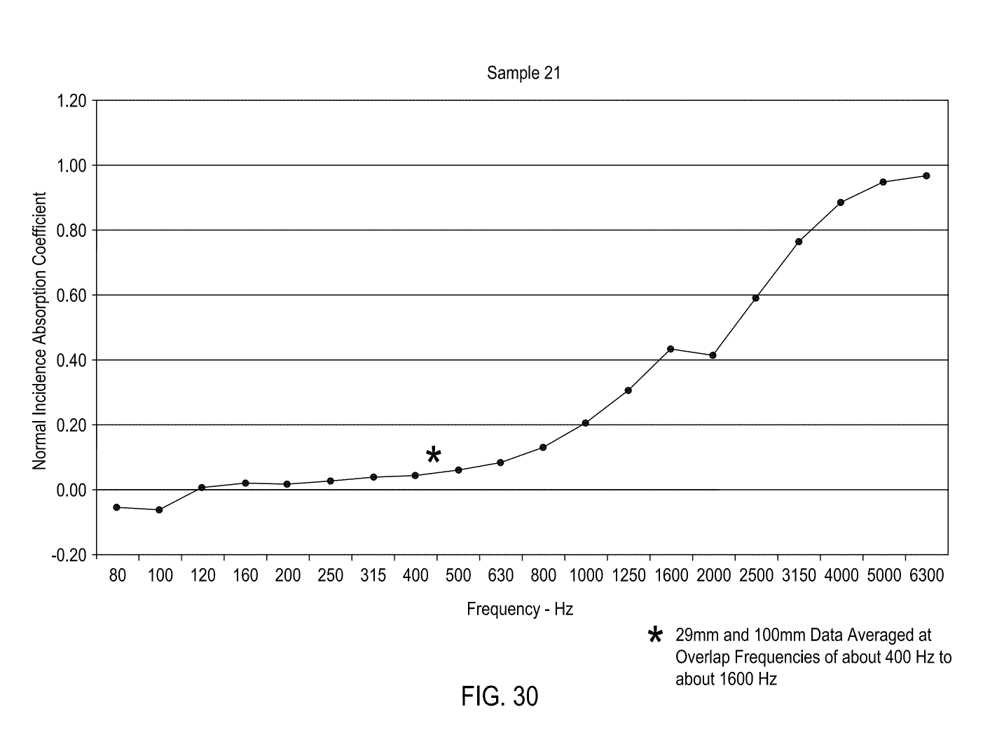

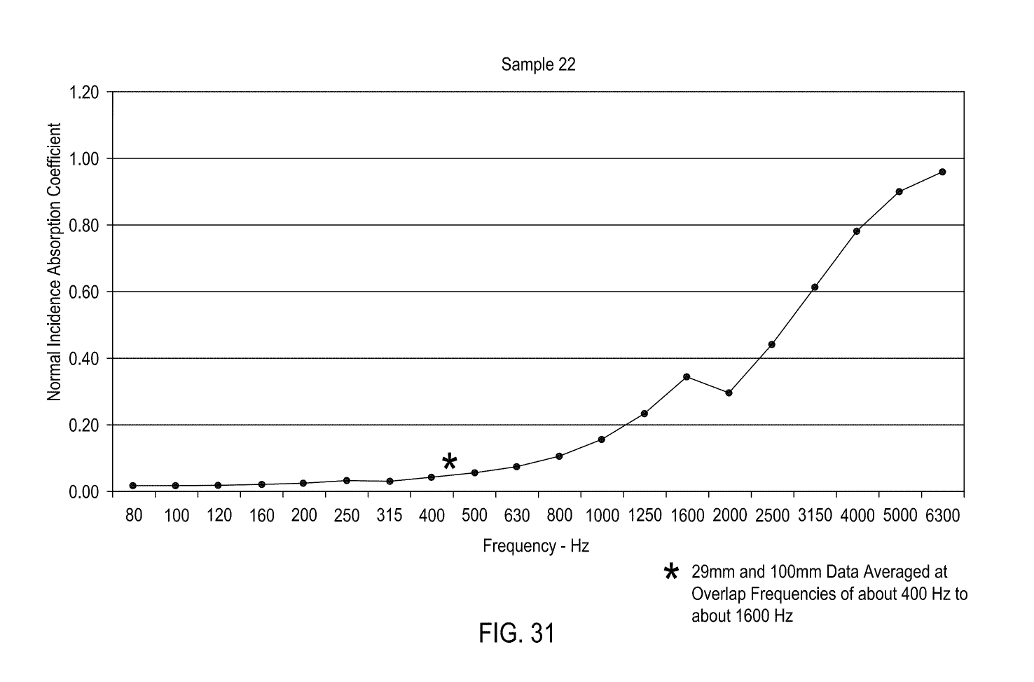

Samples 21 and 22 were tested for normal incidence sound absorption via ASTM E-1050, the results of which are presented in FIGS. 30-31, respectively. Samples 21 and 22 demonstrate good acoustic dampening properties. It should be noted that the dip in the graphs of FIGS. 30-31 were due, at least in part, to the sample used to test the lower frequencies having a thickness of about 10 mm and the sample used to test the higher frequencies having a thickness of about 16 mm. The differences in sample thickness were due to sample preparation. The lower frequency sample was prepared by die cutting a larger piece of the sample with a 29 mm diameter die, and the higher frequency sample a 100 mm diameter die. This procedure caused the edges to crimp together an create a “pillow-like” structure.

Utilizing the data in Table 16, a noise reduction coefficient (“NRC”) was calculated for sample 22. Further, similar data was collected for other commercially available materials utilizing the same procedures at the same thickness of about 13 mm (about 0.5 inches). The calculated noise reduction coefficient for each are provided in Table 17.

TABLE 17

| Material | Calculated NRC |
|---|---|
| Sample 22 | 0.4 |
| 120 g/ft² K10 polyester | 0.26 |
| 3PCF fiberglass | 0.24 |
| polyurethane foam having a density of | 0.17 |
| 0.028 g/mL | |

This example demonstrates the versatility, in at least some embodiments, of the heated collectors and systems of the present invention for producing in situ core/skin nonwoven materials with desired characteristics. This example also further demonstrates the ability to produce in situ core/skin nonwoven materials with unique structures that can be characterized as having excellent thermal insulation properties and good acoustic dampening properties. Further, because the production method utilizes a single collector and does not involve secondary steps to attach the in situ core/skin nonwoven material to another layer, this example demonstrates the unique structures and advantageous systems and methods described herein.

This example further demonstrates the versatility, in at least some embodiments, of the heated collectors and systems of the present invention for producing in situ core/skin nonwoven materials with desired characteristics. Further, this example demonstrates that in situ core/skin nonwoven materials may be prepared with different core and skin structures, each of which may be advantageous in various products and applications.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
forming a plurality of polymer melt filaments;
passing the plurality of polymer melt filaments through a heated collector thereby forming an in situ nonwoven material that comprises a skin formed in situ on at least one outer side of a core.

2. The method of claim 1, wherein the skin is disposed about the core.

3. The method of claim 1, wherein the core comprises a substructure selected from the group consisting of substantially homogeneous, corrugated, gilled, any hybrid thereof, and any combination thereof.

4. The method of claim 1, wherein the skin has a thickness of about 50 microns to about 1000 microns.

5. The method of claim 1, wherein the in situ nonwoven material has a caliper of about 3 mm or greater.

6. The method of claim 1, wherein the in situ nonwoven material has a bulk density of about 0.5 g/cm³ or less.

7. The method of claim 1, wherein the in situ nonwoven material has a basis weight of about 1500 g/m² or less.

8. The method of claim 1, wherein the in situ nonwoven material has an oil absorbency measure of about 2 g/g or greater.

9. The method of claim 1, wherein the in situ nonwoven material has a water absorbency measure of about 2 g/g or greater.

10. The method of claim 1, wherein the in situ nonwoven material has an air flow resistivity of about 250 Rayles or greater.

11. The method of claim 1, wherein the in situ nonwoven material has an air permeability of about 750 cfm/ft² or less.

12. The method of claim 1, wherein the in situ nonwoven material has a normal incidence absorption coefficient of about 0.4 or greater over a frequency range from about 1250 Hz to about 6400 Hz for a thickness of about 0.5 inches or less.

13. The method of claim 1, wherein the in situ core/skin nonwoven material has a normal incidence absorption coefficient of about 0.04 or greater over a frequency range from about 200 Hz to about 2000 Hz for a thickness of about 0.5 inches or less.

14. The method of claim 1, wherein the situ nonwoven material has an R-value between about 1.25 hr*ft₂*° F./Btu and about 2.5 hr*ft₂*° F./Btu.

15. An in situ nonwoven material comprising:
a skin formed in situ on at least one outer side of a core.

16. The in situ nonwoven material of claim 15, wherein the skin is disposed about the core.

17. The in situ nonwoven material of claim 15, wherein the core comprises a substructure selected from the group consisting of a substantially homogeneous, corrugated, gilled, any hybrid thereof, and any combination thereof.

18. The in situ nonwoven material of claim 15, wherein the skin has a thickness of about 50 microns to about 1000 microns.

19. The in situ nonwoven material of claim 15, wherein the in situ nonwoven material has a caliper of about 3 mm or greater.

20. The in situ nonwoven material of claim 15, wherein the in situ nonwoven material has an air flow resistivity of about 250 Rayles or greater.

21. The in situ nonwoven material of claim 15, wherein the in situ nonwoven material has an air permeability of about 750 cfm/ft² or less.

22. The in situ nonwoven material of claim 15, wherein the in situ nonwoven material has a normal incidence absorption coefficient of about 0.4 or greater over a frequency range from about 1250 Hz to about 6400 Hz for a thickness of about 0.5 inches or less.

23. The in situ nonwoven material of claim 15, wherein the in situ core/skin nonwoven material has a normal incidence absorption coefficient of about 0.04 or greater over a frequency range from about 200 Hz to about 2000 Hz for a thickness of about 0.5 inches or less.

24. The in situ nonwoven material of claim 15, wherein the in situ nonwoven material has an R-value between about 1.25 hr*ft₂*° F./Btu and about 2.5 hr*ft₂*° F./Btu.

25. A sound dampening material comprising the in situ nonwoven material of claim 15.

26. A thermal insulation material comprising the in situ nonwoven material of claim 15.

27. A fluid filter comprising the in situ nonwoven material of claim 15.

28. A product comprising the in situ nonwoven material of claim 15, the product being at least one selected from the group consisting of a hygiene product, a disposable medical product, an insulation product, a furniture textile, a sorbent, a horticulture product, a shoe insert, a carpet, a carpet backing, a vehicle, a vehicle interior, and a container.

29. A system comprising:
at least one polymer melt extruder having a plurality of dies; and
a heated collector in communication with the at least one extruder to receive a plurality of polymer melt filaments from at least one extruder to form an in situ nonwoven material that comprises a skin formed in situ on at least one outer side of a core.
